(19) United States
(12) Patent Application Publication
(10) Pub. No.: US 2003/0127376 A1
(43) Pub. Date: Jul. 10, 2003

(54) Fluid control systems

(76) Inventors: Thomas Merlin Maddock, Pontycymer (GB); Alun Kynric Lewis, Cardiff (GB)

Correspondence Address: CHRISTOPHER P. MAIORANA, P.C., 24025 GREATER MACK, SUITE 200, ST. CLAIR SHORES, MI, 48080, US

(21) Appl. No.: 10/104,470

(22) Filed: Mar. 22, 2002

(30) Foreign Application Priority Data
Jan. 5, 2002 (GB) 0000046.3

(51) Int. Cl. B01D 17/025

(52) U.S. Cl. 210/114; 210/134; 210/539; 210/521

(57) ABSTRACT

Apparatus for use in, for example, separating oil from water, which comprises a vortex chamber adapted to admit through an inlet a flow of oil and water, means, (e.g. a helical coil shaped wall member of a “Clock Spring Guide”), device adapted to impart a rotational movement to the admitted oil and water so as to form within the chamber a rotating fluid mass within which a nonturbulent vortex of oil floats on the water. Oil removal pipe provides means for the removal of oil from the oil vortex, and outlet means located below the level of the floating oil provides for the escape of water from the vortex chamber. Variable flow regulating means is located at or downstream of the outlet means to regulate the rate of flow of water through the chamber. A tilted corrugated plate separator housed in chamber may be interposed between the water outlet means of the vortex chamber and the variable flow regulating means to separate residual oil in the emergent water. Oil removal pipe inlets lead out of chamber from the zones where layers of separated oil accumulate. The variable flow regulating means serves to control the fluid surface levels in both vortex chamber and separation chamber. Removal of separated oil of its own accord during operation through any oil removal pipe inlet is secured by setting the relative levels of the rim of such inlet and the fluid surface level provided by the downstream variable flow regulating means so that when water alone constitutes the flow, the rim is located above, but close to the water surface level but, when the fluid surface level is raised by accumulation of floating oil around or proximate to the inlet, oil flows over the rim into the oil removal pipe.

This application claims the benefit of PCT Application No. PCT/GB00/03658, filed Sep. 21, 2000, United Kingdom Application No. 9922369.5, filed Sep. 22, 1999, United Kingdom Application No. 9922368.7, filed Sep. 22, 1999, United Kingdom Application No. 9922717.5, filed Sep. 27, 1999, United Kingdom Application No. 9925767.7, filed Nov. 1, 1999 and United Kingdom Application No. 0000046.3, filed Jan. 5, 2000.

This invention relates to fluid control systems for use in, for example, separating a first liquid from a second body of liquid such as, in particular but not exclusively, separation of oil from water.

Sluice gates generally are well known. In this specification, the expression “sluice gate” is to be construed as including an arrangement comprising a barrier plate free to slide vertically so as to regulate the level of the surface of a body of water or other liquid by controlling flow into or out of it. The barrier plate may act as a weir, with its upper edge constituting the weir rim. Where any part of the weir rim is located at a level that is below the level of the surface of the body of water or other liquid, the difference between the respective levels will control the rate of flow.

Sluice gates adapted to operate as weir flow control means are generally mounted between the facing side walls of an open channel. In order to ensure reliable regulation of the flow over a weir rim, the rim is usually maintained in a horizontal disposition when it is raised or lowered: This may be done by the use of synchronised lifting and lowering means acting one on each side of the weir barrier plate, or else by the use of firmly anchored central lifting and lowering means. Guide means located on the facing side walls guide the upward and downward movement of the plate. Means must be provided to ensure an unbroken underwater seal at the sides and along the length of the lower part of the barrier plate.

In the regulation of the surface level of an upstream body of water or other liquid, the longer the weir rim, the greater the capacity of the sluice gate and the more quickly will regulation take effect. But the longer the weir rim and its attendant barrier plate, the greater the space required to accommodate them. Moreover, the longer the barrier plate, the greater the precautions that must be taken against the tendency of the liquid pressure on the one side or the other to deform the plate. Moreover, barrier plates that traverse broader channels require correspondingly stouter side channel mountings.

According to a first aspect of the present invention, there is provided a weir valve arrangement which comprises a pipe member having an expanded upper end bounded at least in part by a rim, the length of the rim being greater than the inner circumference of the pipe, together with means whereby the vertical disposition of the rim may be regulated so that it acts as the rim of a weir of variable height that governs:

i. the rate of flow of liquid out of, or alternatively into the pipe and/or

ii. respectively the surface level of a body of liquid which for the time being is:

a. connected to liquid within the pipe, or

b. connected to liquid outside the pipe.

The rim may be provided with a projection, preferably contained and maintained in a substantially horizontal plane, with the length of the projection being greater than the inner circumference of the pipe.

The length of the rim or of its horizontal projection as the case may be preferably exceeds the inner circumference of the pipe by a factor of at least two to one, and advantageously of at least three to one, and usefully of at least four to one.

According to a preferred embodiment of the first aspect of the present invention, the rim may be provided with one or more upwardly extending projections having in between them apertures through which liquid will flow when the liquid surface level lies between the lower and upper ends of the projections. Such apertures may have either:

A. Geometrical shapes such that the cross sectional area of the liquid flow therethrough over the weir rim may be calculated by reference to the height “h” of the liquid surface level above the lower end of the projections, or

B. Shapes that do not readily enable such calculations to be performed.

In the case of A above, the projections may, for example, be rectangular or “castellated” in shape so as to provide rectangular apertures. Alternatively, the projections may be triangular, in which case the apertures take the form of triangles and/or trapeziums. Rectangular apertures will provide a linear relationship between the variation of the relevant area and the change in the height of h of the fluid surface. In the case of rectangular or trapezoidal apertures, the area in question will vary according to a function that brings in the square of h. In any particular case, the geometry of the apertures may be selected so that the variation of the relevant area with regard to a variation in h may be calculated. In the case of B above, the rate of flow and its variation by reference to h or changes in h respectively may be ascertained and calibrated by trial and error. The same also clearly applies to cases under A above.

Preferred embodiments of the first aspect of the invention may include the feature whereby the apertures are constituted at least in part by holes in the side of the expanded upper end of the pertinent pipe member. Moreover, the expanded upper end may be adapted to constitute the lower part of an apertured chamber with a close top, e.g. a drum shaped or globular chamber with holes in its sides and designed to operate over a particular limited range of liquid surface levels.

In a preferred embodiment of the first aspect of the present invention, there is provided a telescopic mounting as between the rim bearing pipe member and its support. Such support may be constituted by a lower fixed pipe member or a fixed socket or other appropriate aperture support member. Precision in the regulation of the upward and downward movement of the supported pipe member and of the vertical disposition of its associated rim may readily be secured by means well known per se, for example by way of an appropriate screw threaded telescopic mounting, other screw mounting, rack and pinion means or intermediate support members of adjustable length. Where precise regulation is not called for, the pipe member may be friction mounted.

The weir valve arrangement of the first aspect of the present invention may be located within a chamber so as to regulate liquid flow through the chamber in either direction. Thus the liquid may flow over the weir rim during operation either outwardly from the pipe or, alternatively, inwardly into the pipe. Alternatively, the arrangement may be used as a one way valve permitting flow in one direction only, e.g. when regulating the surface level of an upstream body of liquid connected to the arrangement.

The expanded upper end of the pipe member may advantageously be in the form of a dish connected to the remainder of the pipe member and providing access into and out of the same through a central base aperture.

Weir valve arrangements according to the first aspect of the present invention have the following advantageous characteristics:

i. They provide a relatively long weir rim which can be accommodated within a limited space. Thus as compared with the straight line weir rim of a sluice gate, the horizontal weir rim according to the first aspect of the present invention provides an advantage in rim length of the order of Pi (3.142) to one. So also does the horizontal project of the weir rim according to the second aspect of the present invention. The longer the weir rim of a conventional sluice gate, the greater the care that has to be taken to ensure a horizontal disposition of the rim, a smooth sliding fit within the side guide plates and an effective seal below the liquid surface. Moreover, the longer the barrier plate, the greater its tendency towards distortion as a result of liquid pressure.

ii. A dish shaped pipe end may readily be manufactured and mounted symmetrically onto a pipe with precision. The pipe itself may be mounted as indicated above for precisely controlled upward and downward telescopic movement. No precautions are required to ensure that any one end of a weir rim is at the same horizontal level as the other.

iii. By the very nature of their construction, the rims and rim supports of the weir valves of the invention are not susceptible to buckling forces under pressure as are the rims and barrier plates of conventional sluice gates.

iv. In the use of a sluice gate, the integrity of the extended seal running along the length of the lower part of the barrier plate and its side edges must be maintained. The entry of disruptive foreign matter into exposed guide means must be avoided. On the other hand, the preferred embodiment of a weir valve of the first aspect of the present invention enjoys the advantages that can be provided by telescopic mounting, including the use of compact, reliable and protectable sealing means such as “O” rings or appropriate bushes between the weir rim bearing pipe and its mounting.

v. Weir valve arrangements of the present invention can provide reliable and readily assembled flood control means for industrial and engineering installations.

vi. The arrangement of the first aspect of the present invention provides a reliable, economical, easily operated and potentially high precision alternative to conventional sluice weir valves.

It should be noted that in the following description, any reference to “water” is to be construed as meaning any liquid in respect of which a weir valve according to the first aspect of the invention may be required to be used.

Tilted plate separator oil interceptors are well known. Such interceptors (referred to below as “tilted plate separators”) are provided with banks of tilted plates having corrugations which, in use, extend longitudinally along the direction of fluid flow or, as in the case of the CROSSPAK (T.M) Compact Separators, transversely and across such direction. When oil-contaminated water flows through a tilted plate separator, dispersed globules of oil coalesce to form oil droplets. On achieving a critical size, such droplets rise to the water surface. In an analogous manner, when using such separators to separate from water flowable particles having a higher density than water, the separated particles flow downwardly in a slurry-like mass until they are tipped off the lower edges of the corrugated plates. The corrugations described and used according to the prior art are in general of a substantially uniform cross sectional shape along their lengths.

According to a second aspect of the present invention there is provided a corrugated plate for use in separating two masses of flowable matter having different specific gravities, said corrugated plate comprising adjacent longitudinal grooves disposed between corresponding ridges, the depth of each groove being arranged to increase progressively simultaneously with a progressive decrease in the mean angle between the groove sides along the one or other longitudinal direction.

For the purposes of this specification, the expression “the mean angle between the groove sides” shall mean the angle between two lines, each extending upwardly from the same point on the base line of a groove, the one to the ridge line running along the ridge located on the one side of the groove and the other to the ridge line running along the ridge located on the other side of the groove, both of the upwardly extending lines as seen in plan view being disposed at right angles to the said base line.

Also according to the second aspect of the present invention, there is provided apparatus for separating two masses of flowable matter having different specific gravities which comprises at least one, and preferably a plurality of tilted corrugated plates, the or each plate comprising adjacent longitudinal grooves disposed between corresponding ridges, the depth of each groove being arranged to increase progressively simultaneously with a progressive decrease in the mean angle between the groove sides along the one or other longitudinal direction.

Furthermore, in accordance with the second aspect of the invention, there is provided a method of separating two such masses by the use of such apparatus.

Although in its broadest scope, the second aspect of the present invention provides means and a method for the separation of a liquid and a flowable mass of denser particles, it will be appreciated that its principal application lies in the provision of means and a method for the separation of two liquids having different respective specific gravities, in particular, oil and water.

A particularly important preferred feature of the second aspect of the present invention lies in the provision of apparatus as mentioned above for separating two liquids of different specific gravities which comprises downstream valve means for controlling during operation:

i. Fluid flow through the apparatus and/or

ii. The fluid surface level or levels within the apparatus.

By “fluid surface level” is meant the uppermost liquid surface level at any point. Thus when water only is present, the fluid surface level will be the surface level of the water. But when a layer of oil floats on the water, the fluid surface level will be the surface level of the oil.

The use of the downstream valve means referred to enhances the efficiency and reliability of the apparatus and facilitates a way of carrying out the invention in which separated liquid of lower specific gravity, e.g. oil may be arranged to flow out of the apparatus of its own accord.

In practice, the preferred form of downstream valve means is a weir valve, and most preferably a weir valve as defined in accordance with the first aspect of the invention. For the purposes of the remainder of this specification, such a weir valve is referred to herein as a “Tulip Valve”.

A corrugated plate of the second aspect of the invention, when made from sheet material will have on its reverse side complementary ridges and grooves which correspond with the grooves and ridges respectively on its face side. The cross-sectional shape of the individual grooves progressively changes as one progresses in the one or other longitudinal direction along the groove. As the depth of a groove increases, the mean angle between the sides decreases, and vice versa. Thus where a groove has substantially planar side walls, its cross sectional shape at one end will be that of a shallow “V” or, in the limiting case, a straight line. Each arm of the “V” becomes longer as the depth of the groove increases in the direction towards the other end, whilst the angle between the arms becomes smaller; and vice versa in the opposite direction.

When put to use in a tilted plate separator to separate two masses of flowable matter having different specific gravities, each corrugated plate of the second aspect of the invention is arranged to be disposed so that the progressive increase in the depth of the grooves accompanied by a simultaneous decrease in the mean angle between the sides of the grooves occurs in the direction of flow of the flowable matter which:

i. in the case of two liquids, would in most cases, but not necessarily, be along an upwardly inclined path in contact with one or more downwardly facing tilted corrugated plates of the invention; and

ii. in the case of a liquid and a flowable mass of denser particles, would generally, but not necessarily, be along a downwardly inclined path in contact with one or more upwardly facing tilted corrugated plates defined in accordance with the second aspect of the invention.

In exceptional cases, the flow in the case of two liquids may be along a downwardly inclined path in contact with one or more downwardly facing tilted corrugated plates of the invention with their grooves increasing in depth or height and the mean angle between the groove walls decreasing the direction of flow.

Arrangement of the tilted plates.

Tilted plate apparatus defined in accordance with the second aspect of the invention, for separating two liquids of different specific gravities is assembled using one or a plurality of separator plates of the invention. Where a plurality of plates is used, the plates may be arranged as:

i. “Stacked Plate” units, or

ii. A “Serial Plate” arrangement which consists of

a. a series of single plates of the present invention acting in sequence, or

b. a series of discrete Stacked Plate units acting in sequence, or

c. any combination of a and b.

Stacked Plate Unit.

By this expression is meant a plurality of corrugated plates defined in accordance with the second aspect of the invention arranged in a stack of substantially parallel tilted plates. Within each stack, each intermediate plate is located in close proximity to its neighbouring plates above and below. As in the case of the single corrugated plate of the second aspect of the invention, during operation, the submerged tilted Stacked Plate unit is arranged for upward flow of oil and water along the downwardly facing grooves with the mean angle between the respective groove walls decreasing along the direction of flow. The oil particles tend to rise towards the apices of the inverted grooves. There, they are constrained to move along a path that becomes progressively more restricted. This promotes coagulation leading to the formation of droplets which eventually break free from the upper edges of the plates and float to the surface.

In the alternative and exceptional situation where the flow is in the downward direction, the flow is directed along downward facing grooves with the mean angle between the respective groove walls decreasing along the direction of flow. This will also result in coagulation and the formation of droplets which are driven by the flow to the lower end of the tilted plate or plates from where they may be swept along to a zone where they rise to the surface.

In the case of the separation of liquid from a flowable mass of denser particles, a plate or a stack of corrugated plates according to the second aspect of the present invention is disposed so that upwardly facing plates accept a downwardly flowing stream of liquid carrying with it a slurry of particles. The mean angles between the sides of the upwardly facing grooves decrease along the direction of downward flow. The particles of the slurry are forced closer together. They eventually fall off the lower edge or edges of the plates.

In the case of known tilted plate oil separators, the plates within the plate packs are often inclined at an angle of 45 degrees to the horizontal. This inclination is said to represent the optimum for maximising the effect separation surface area and for promoting the movement of oil along the underside of each plate. The expression “effective separation surface area” in this context represents the horizontal component of the surface area of the inclined plates.

By adopting the groove design of the second aspect of the present invention, the “effective separation surface area” of the corrugated plates remains unchanged. On the other hand, the sides of the corrugations become progressively steeper and larger in area along the direction of flow.

“Plate Divergence Angle” and “Mean Plate Line”.

As seen from a side view (i.e. in elevation), the lines of the respective ridges on the upper and under side of each plate will diverge along the direction of flow. For the purposes of this specification, the angle of divergence will be referred to as “the Plate Divergence Angle”. The expression “Mean Plate Line” will be used to designate the line that bisects the Plate Divergence Angle.

When using corrugated plates defined in accordance with the second aspect of the present invention in tilted plate separators, the Mean Plate Line may be inclined at an angle of 45 degrees to the horizontal. However, it will be a matter of trial and experiment in any particular case to ascertain the most favourable Plate Divergence Angle and Mean Plate Line inclination having regard, inter alia, to the relative proportions of oil and water in the oil/water feed, the rate of flow of the feed, the degree of final separation aimed for and the viscosity of the oil to be separated.

The grooves or corrugations of the plate defined in accordance with the second aspect of the present invention when seen in plan view may run parallel to each other. However, if desired, such corrugations when seen in plan view may be formed so as to diverge in the direction of flow, or, alternatively, to converge in such direction. The optimum disposition of the corrugations for any particular purpose is arrived at by calculation and/or by trial and error having regard to the particular type of separation called for.

The downwardly facing grooves of the corrugated plate defined in accordance with the second aspect of the present invention may be provided with additional means to promote the coagulation and/or aggregation of small droplets held in suspension in the feed liquid, e.g. ribs or projections which may, for example, be of a “herringbone” pattern adapted to direct droplets towards the apex of a groove.

The Mean Plate Lines (as defined above) of like facing grooves in adjacent plates within a stack of plates are, in general, aligned parallel to each other. Given a constant overall rate of flow, the geometry of the arrangement will determine at any part along the length of a plate the ratio of the surface contact area to the rate of flow. This ratio will be varied where the distance and/or the angle between the Mean Plate Lines of adjacent plates is varied. This is a consideration which may be borne in mind when seeking the optimum operating design in a particular case.

Serial Plate Arrangement

This arrangement is directed to the separation of two liquids exemplified below by oil and water. In the Serial Plate arrangement, tilted corrugated plates, each defined in accordance with the second aspect of the invention, are arranged so as to act in sequence within a separation chamber to separate oil from water. The sequence may be of single tilted corrugated plates of the invention, or of discrete tilted Stack Plate units of two or more corrugated plates according to the second aspect of the invention, or of single tilted plates and discrete units disposed in any order so as to act in sequence along the line of the fluid flow. The use of Stacked Plate units can enhance the working capacity of a separation chamber that is enclosed within a limited space.

The corrugated plates of the Serial Plate arrangement are aligned in sequence below the water surface within a separation chamber and are tilted so that the mixture comprising oil and water flows in an upward direction in contact with the downwardly facing grooves whose depth increases in the direction of flow. The upper edge of each plate terminates below the liquid surface. Oil and/or droplets of coagulated oil break off the upper edge and rise to the surface. The area where the oil separated out by the first tilted plate or tilted Stacked Plate unit accumulates is referred to for the purposes of this specification as “the first surface accumulation zone”. A barrier extending downwardly from above the fluid surface isolates the first surface accumulation zone from a second corresponding surface accumulation zone which receives oil from the upper rim or rims of a second tilted plate or tilted Stacked Plate unit. Likewise, each successive like surface accumulation zone in sequence is isolated by a barrier from its preceding surface accumulation zone. The barrier in each case directs the flow of water down to the vicinity of the base of the separation chamber. The water takes with it the oil that has not been left behind in the previous surface accumulation zone. The fluids flow under the barrier and then upwardly in contact with the downwardly facing grooves of the next grooved plate or Stacked Plate unit as the case may be. Oil that is separated out by such grooved plate or Stacked Plate unit rises to the surface of the next surface accumulation zone. The sequence is repeated as many times as may be deemed necessary or desirable to achieve the required degree of separation. Oil in progressively diminishing amounts accumulates in the successive surface accumulation zones. Oil depleted water is removed from below the liquid surface of the last surface accumulation zone. If desired, such water may be passed through a filter matrix to entrap finely divided oil particles that have survived passage through the separation chamber.

Removal of Separated Oil: “Density Differential” Principle.

The separated oil may be removed from the respective surface accumulation zones by conventional means such as the use of suction pipes, siphons, scoops or buckets.

Preferably, however, the oil is removed according to an important principle according to which separated oil flows out of the apparatus of the second aspect of the invention for collection and storage of its own accord. This aspect brings into play what is referred to herein for the purposes of the remainder of this specification as the “Density Differential” principle.

When a layer of oil floats on water, the fluid surface level is elevated. This phenomenon is a necessary consequence of the difference between the respective specific gravities of oil and water. Since the specific gravity of floating oil is less than that of the underlying water, it follows that the volume of floating oil required to displace a given volume of water will be greater than the volume of the water displaced. The thicker the layer of the floating oil, the more will its surface level be elevated. Here lies the Density Differential principle.

In order to apply this principle to the separation of oil and water according to the second aspect of the present invention, there are provided within the several surface accumulation zones or within selected zones oil removal pipe inlets leading onto oil removal pipes. The rims of the respective inlets are positioned at a level set by reference to the “normal” working level of water in the separation chamber when the apparatus is put to work. In general, such level is imposed by the level of the separation chamber's fluid outlet. The rims of the several inlets are set at a level that is a short distance above the said normal working level of the water. In an advantageous working embodiment, each inlet member faces upwardly and is adjustably mounted on its associated oil removal pipe so that the inlet, and with it the level of its rim may be raised or lowered.

In such advantageous working embodiment the rim levels are set so that:

1. when water alone flows through the separation chamber, the inlet rims stand proud of the water surface, but

ii. when a surrounding or proximate layer of floating oil attains a particular thickness, oil flows over the rim and into the inlet.

During the operation of the Serial Plate separator arrangement, oil will accumulate at the fastest rate within the first surface accumulation zone. The oil will likewise accumulate in the successive surface accumulation zones, but at successively slower rates. Depending on the circumstances and the number of successive surface accumulation zones, the rate of accumulation in any one or more such zones downstream may be negligible. Up to that point, separated oil that attains a fluid surface level above the level of the rim of any removal pipe inlet flow out through the inlet of its own accord.

Following passage through the last surface accumulation zone and the removal of almost all of the oil, the water will still carry with it traces of residual oil in the form of very finely divided particles which are resistant to coagulation into droplets. At that stage, further oil separation may be carried out by passing the water through an oil absorbent matrix filter of a known kind, e.g. a porous polyurethane foam or matted fibre matrix of the kind widely used in oil/water separators. Preferably, this is done by way of a downward flow.

In many current oil/water separators, such matrices or a sequence of such matrices with varying degrees of porosity constitute the principal expedient whereby the oil is separated from water. In such arrangements, they absorb a substantial proportion if not all of the oil that is separated. When the filters become saturated, they must be re-constituted or replaced. This limits their utility where there is a high percentage of oil in the water/oil feed flow. It also entails additional steps and expense in the recovery of the oil from the filter matrices.

The method of the second aspect of the present invention, on the other hand, ensures that the filter matrix is called upon to deal with no more than residual traces of oil present in the water flowing out of the separation chamber. The cost and effort involved in reconstituting and/or replacing the filter matrix is substantially reduced. Almost all of the oil that was in the original feed mixture flows out of the separation chamber of its own accord for immediate collection and storage. No further steps are necessary for its recovery.

Surface Level and Flow Control.

The operation of the apparatus defined in accordance with the second aspect of the present invention is much enhanced by the use of reliable and accurate downstream means for controlling the fluid surface levels within the apparatus and the related feature of the control of rate of flow through the apparatus. With reliable control of fluid surface levels and/or fluid flow, the apparatus may be adapted for trouble free operation under different conditions and in conjunction with fluids of varying densities and viscosities to give a satisfactory measure of separation.

The control means may comprise a conventional flow control valve such as a gate valve that is operated manually or governed by sensors that respond to fluid surface levels within the separation chamber. Alternatively and advantageously, control may be by weir flow control over the rim of a downstream sluice gate. In the preferred embodiment of the invention, control is effected by the use of a Tulip Valve.

The description that follows the use of the Differential Density principle in the method of the second aspect of the present invention is directed, where relevant, to the use of such a Tulip Valve. Other valve means may be employed in the same manner as a Tulip valve, although they are not considered to afford the same ease of operation or the same precision and reliability.

Downstream Surface Fluid Level Control.

In the context of the second aspect of the present invention, the Tulip Valve regulates the flow of decontaminated water that has passed through the separation chamber. The setting of its weir rim also determines the fluid surface level upstream in the separation chamber. It can thus be used to set the working surface level of the water that flows through the separation chamber by suitable adjustment of the level of its weir rim. This having been done, the level of the oil removal inlet rims are adjusted so that the inlet rims become positioned at the appropriate short distance above the working surface level of the water. This short distance will represent the desirable extent of the rise of the fluid surface level of a thickening layer of floating oil above the working water level as the layer accumulates additional oil. As soon as the fluid surface level of the oil moves upwardly more than the short distance, oil pours into the inlet. Alternatively, of course, given a satisfactory initial level on the part of the inlet rims, the level of the Tulip Valve weir rim may be adjusted by reference to the level of the weir rims to achieve a like result.

A filter matrix chamber may be included in the main flow stream, either between the separation chamber and the Tulip Valve or downstream of the Tulip Valve.

In addition to facilitating the application of the Density Differential principle, the Tulip Valve may be usefully employed in regulating precisely and reliably the rate of flow through the apparatus of the second aspect of the invention. Advantage may be taken of the ease and potential high precision of its operation.

Upstream Stabilisation.

There are circumstances where the manner of the transference and delivery of the oil and water feed mixture to the separation chamber can given rise to random irregularities in the rate of flow and to the transmission of disruptive elements within the flow. For example, direct pumping of an oil/water mixture can result in the transmission of turbulence, pulsations and/or vibrations which can be prejudicial to the stability and smooth running of the separation process. The situation is aggravated when air is admixed with the oil/water mixture. Such admixture is inevitable when the oil/water feed mixture is drawn from a surface oil skimmer such as the skimmer described in the specification of our co-pending international patent application No. PCT/GB99/01327. In this and in other cases, it is desirable to stabilise the flow before it enters the separation chamber. However, where the apparatus of the second aspect of the invention receives its feed mixture by way of gravity flow from a tank or reservoir, the problems referred to above seldom arise.

It is known to separate oil from water by methods which include the formation of a rotating fluid mass in which separation occurs under the influence of centrifugal forces. Where the oil and water to be separated are present in a naturally occurring or artificially generated moving stream, it is well known to generate the rotational movement by causing tangential entry of the flow into a suitably shaped chamber or enclosure whose walls direct the flow into a rotational path.

In the VORTOIL (T.M) system, oil contaminated water passes under pressure through a tangential inlet at high speed into a hydro cyclone chamber to create a swirling vortex in which the fluid swirls at rates of up to 30,000 rpm. Very high centrifugal forces are generated and the oil migrates almost instantly to the core of the vortex from which it is withdrawn through an outlet located near the inlet. The de-contaminated water is discharged from the other end of the hydro cyclone chamber.

In the CYCLONFT (T.M) system, a unit which comprises a hydrocyclone chamber and a forwardly directed scoop is attached to a boat. When the boat is driven forward, the scoop skims floating oil and a moderate amount of surface water. The fluids are driven through a tangential inlet slot leading into the hydrocyclone chamber which is tapered towards its base. A tangential outlet slot is located adjacent to the base. By reason of the forward speed of the boat and the tangential entry and outlet slots, the fluids form a rotating mass in which oil separates from the water by centrifugal force and gravity and rises to the top whence it is pumped out to storage. Oil decontaminated water flows out through the tangential outlet slot. During operation, the CYCLONET units may be mounted on either side of the hulls of trawlers, supply vessels, barges, and sea-going tugs. The operating speed is in the region of 3.10 knots. The rate of flow of water through the CYCLONET hydrocyclone chamber and the fluid surface level within the chamber will be governed by the dimensions of the slots, the forward speed through the water of the boat to which the unit is attached and/or the depth at which the scoop is set. The decontaminated water flows freely out of the chamber through the tangential outlet slot and away into the surrounding body of water.

In another system referred to by its promoters as “Captain Blomberg's Hydrodynamic Circus”, boom means are used to direct floating oil carried by a river or tidal flow into the side inlet of a hexagonal enclosure defined by its side walls and open above and below. The enclosure is mounted on a small boat provided with a pushing rudder on the opposite side of the enclosure. The side inlet with its boom means are disposed to face upstream. The side inlet provides what may loosely be called a tangential entry into the enclosure. Within the enclosure, floating oil and a layer of water on which it floats are diverted by the side walls so as to form an eddy within which the oil accumulates at its centre. The oil is sucked out of the centre of the eddy and is passed to a floating storage bag. The water flows out through the open base area of the enclosure to re-join the river or tidal flow below.

In general, the third aspect of the present invention relates to apparatus and a method for separating oil from water in which rotational movement is imparted to a flow of oil and water admitted into a vortex chamber so as to form a rotating fluid mass within which a non-turbulent vortex of oil floats on a swirling stream of water that passes through the chamber. The water escapes from the vortex chamber through outlet means located below the level of the floating oil. The third aspect of the present invention in its several realisations brings in the regulation of the associated features of

(a) The rates of fluid flows through the vortex chamber, and

(b) Fluid surface levels within the vortex chamber and externally at the inlet. In each case, the level will depend upon the downstream fluid flow associated with it.

The expression “fluid surface level” as used in the remainder of this specification shall be construed to mean the uppermost liquid surface level at any point. Thus, where water alone is present, the fluid surface level will be level of the surface of the water. But where oil floats on the surface of the water, the fluid surface level will be the level of the surface of the oil.

In the working of the several realisations of the third aspect of the invention, the fluid flows and surface levels of both water and oil and their mutual interaction fall to be considered. Regulation of any one or more of the fluid flows can influence the operation other fluid flows and hence the fluid surface levels with which the others are associated in a complex hydrodynamic system.

Direct Regulation of Water Flow “Means A”.

According to a first realisation of the third aspect of the present invention, there is provided apparatus for separating oil from the water which comprises:

i. a vortex chamber adapted to admit through an inlet a flow of oil and water;

ii. means adapted to impart a rotational movement to the admitted oil and water so as to form within the chamber a rotating fluid mass within which a non-turbulent vortex of oil floats on the water;

iii. means for the removal of oil from the oil vortex;

iv. outlet means adapted to be located below the level of the floating oil for the escape of water from the vortex chamber; and

v. variable flow regulating means located at or downstream of the outlet means and adapted to regulate the rate of flow of water through the chamber.

It is important to appreciate a full understanding of the third aspect of the present invention that the variable flow regulating means as mentioned under (v) above will also serve to regulate the fluid surface level within the vortex chamber. In general, in the context of the third aspect of the present invention and in the absence of other factors, regulation of a fluid flow will inevitably result in the regulation of the fluid surface level of the liquid upstream, and vice versa.

Separation of Floating Oil.

There are circumstances where the oil to be separated from water floats as a discrete layer on the water surface. In such a case, the rate of flow of water through the vortex chamber may be regulated indirectly. Such indirect regulation may be additional to or in substitution for the direct regulation of the flow as mentioned above in relation to the third aspect of the present invention.

Indirect Regulation of Water Flow: “Means B”

In accordance with a second realisation of the third aspect of the present invention, there is provided apparatus for separating floating oil from water which comprises:

i. a forward part adapted to receive a flow of water that bears a floating layer of oil;

ii a vortex chamber located downstream of the forward part adapted to admit through an inlet an upper layer of the flow of water together with the layer of oil that floats on such upper layer;

iii means adapted to impart a rotational movement to the admitted oil and water so as to form within the chamber a rotating fluid mass within which a non-turbulent vortex of oil floats on the water;

iv means for the removal of oil from the oil vortex;

v outlet means adapted to be located below the level of the floating oil for the escape of water from the vortex chamber;

vi by-pass means having inlet means in the said forward part adapted to admit water from below the oil/water interface upstream of the vortex chamber inlet and to divert the admitted water past the vortex chamber; and

vii variable flow regulating means adapted to regulate the rate of flow of water through the by pass means.

Variable Flow Regulating “Means A to D”.

Means A.

The expression “Means A” is used herein to refer to the direct variable flow regulating means mentioned under (v) above in relation to the first aspect of the invention. Means A may act alone according to the third aspect of the present invention to regulate the flow of water through the vortex chamber, uninfluenced by any other variable flow regulating means. Use of Means A alone represents the simplest aspect of the working of the third aspect of the present invention. The third aspect of the present invention when broadly defined, covers the cases where one or a plurality of other variable flow regulating means is or are put to use either in conjunction with Means A or otherwise. Each such means will also regulate as a matter of course the particular upstream fluid surface level related to the flow that it regulates. When simultaneous use is made of two or more such means, there is set up a complex hydrodynamic system. The other means are:

Means B.

Means mentioned under iii above in relation to the second realisation of the third aspect of the invention and applicable only where floating oil is to be separated from water,

Means C.

Means adapted to regulate the rate of flow of oil during its removal from the floating oil vortex, and

Means D.

Means adapted to regulate the rate of flow of floating oil into the vortex chamber through the vortex chamber inlet, and applicable as for Means B.

By regulating the rate of flow of water through the by-pass means. Means B is also adapted to regulate the outer fluid surface level upstream of the vortex chamber at its inlet. Given for the time being

i. free entry of the flow of water and floating oil into the vortex chamber;

ii. constant conditions for the escape of water from the vortex chamber; and

iii. the absence of simultaneous variation of any of the other said flow regulating Means, a change in the outer fluid surface level at the vortex chamber inlet results in a corresponding change in the fluid surface level within the chamber. The rate at which water escapes from the vortex chamber is influenced by the hydrodynamic pressure at the water outlet which in turn depends upon the fluid surface level within the chamber.

Hence, where applicable, Means B constitutes a variable flow regulating means which, because of its effect upstream of the vortex chamber inlet is adapted to regulate the rate of flow of water through the chamber.

Regulation of the Rate of Removal of Oil: “Means C”.

According to a third realisation of the third aspect of the present invention, there is provided apparatus for separating oil from water which comprises

a vortex chamber adapted to admit through an inlet a flow of oil and water;

means adapted to impart a rotational movement to the admitted oil and water so as to form within the chamber a rotating fluid mass within which a non-turbulent vortex of oil floats on the water;

means for the removal of oil from the oil vortex;

outlet means adapted to be located below the level of the floating oil for the escape of water from the vortex chamber; and

variable flow regulating means adapted to regulate the flow of oil from the oil vortex and out of the vortex chamber.

Regulation according to Means C will result in the varying of the amount of oil in the oil vortex, and hence its size. This will affect the fluid surface level within the vortex chamber and, as a result, the hydrodynamic pressure at the water outlet.

Regulation of the Rate of Inflow of Floating Oil: “Means D”.

According to a fourth realisation of the third aspect of the present invention, there is provided apparatus for separating floating oil from water which comprises:

i. a vortex chamber adapted to admit through an inlet a flow of water together with a layer of oil that floats on the water;

ii. means adapted to impart a rotational movement to the admitted oil and water so as to form within the chamber a rotating fluid mass within which a non-turbulent vortex of oil floats on the water;

iii. means for the removal of oil from the oil vortex;

iv. outlet means adapted to be located below the level of the floating oil for the escape of water from the vortex chamber; and

v. variable flow regulating means controlling the upper part of the inlet and adapted to regulate the flow of floating oil into the vortex chamber.

Where the flow of oil into the vortex chamber is restricted, an ever thickening layer of floating oil will build up at the inlet and the thickness of the floating oil vortex inside the vortex chamber will decrease, and vice versa. Water continues its flow below the oil layer into the vortex chamber. The factors determining the rate of flow of water through the vortex chamber will include the thickness of the said outer layer of oil and of the inner floating oil vortex, each of which will have a bearing on the hydrodynamic pressure at the water outlet. As the rate of inflow of the floating oil is varied, the rate of flow of water through the outlet will respond pending restoration of a steady inflow of the oil.

Any of the variable flow regulating Means A to D mentioned above may be constituted by fluid valves or gates of the known kind that control the passage of a fluid through a pipe or aperture. Such valves or gates may be operated manually or else automatically in response to signals from sensors located, as may be appropriate, either within the vortex chamber or in the forward part of the apparatus which indicate the surface fluid levels and/or the oil/water interface levels at their several respective locations.

Where the apparatus of the third aspect of the invention is located on a stable support or on a support that is not subject to dissipative periodic or random physical movement, each or any of Means A to D may be operated by reference to the control of fluid flow over a weir rim. The weir rim may be provided by:

(a) a sluice gate arrangement known in accordance with the present invention, or

(b) except in the case of Means D, a downstream weir valve arrangement according to the first aspect of the invention (i.e. the “Tulip Valve”).

The tulip valve is not appropriate for use as Means D. However, Means D may advantageously be operated using a hinged gate extending across the upper part of the vortex chamber inlet and opening to admit fluid flow into the chamber. Preferably, such admission is effected in the same direction as the rotational flow within the chamber at the location of the inlet.

Weir acting sluice gates constitute the preferred form of the regulating Means A and, where called for, Means D and/or Means C. Amongst such gates, Tulip Valves are particularly preferred because of their precision, reliability and ease of handling.

Marine Application.

The apparatus according to all realisations of the third aspect of the present invention as defined above may be mounted on to a boat or else provided with buoyancy means in order to remove floating oil from the surface of a body of water, e.g. out at sea or on a lake, harbour, river or other water surface. For the purposes of the remainder of this specification, such user of the apparatus will be referred to below as “Marine Application”.

The operation may from time to time be affected by wave motion or unpredictable current flows. In Marine Applications of the third aspect of the invention such as the removal of an oil slick at sea, the prime object is frequently the physical removal of as much of the floating oil contaminant as possible. The purity of the water that has passed through the apparatus may well be a secondary consideration. Likewise in an industrial context where the water from which oil has been separated is to be recycled. In such circumstances, submerged sluice gate valves other than those acting by reference to the height of a weir rim (i.e. other than “weir acting sluice gates”) may be found to perform adequately as the variable flow regulating Means A, B and/or C.

On the other hand, when operating on inland waters, the purity of water discharged from the apparatus of the third aspect of the invention could be a matter of prime importance calling for the precision and reliability provided by the Tulip Valve as the Means A. Under calm conditions, the same Tulip Valve may also be employed in the method described below for the removal of residual oil that has survived passage through the vortex chamber.

Rotation of the Fluid Mass within the Vortex Chamber.

When a layer of oil floats on a water vortex, the combination of the resulting drag effect of the water and of centrifugal/centripetal forces transforms the layer into a discrete oil vortex having the shape of an inverted bell-curve that spins around its axis. The height or depth of the curve at its centre will vary, inter alia, with the speed of rotation of the oil up to the point where the speed becomes excessive and oil breaks off the bottom of the vortex.

The rotation of the fluid mass within the vortex chamber may be brought about by tangential entry of a fluid flow into a chamber having an appropriate inner cross-sectional configuration, in particular, a circular inner configuration. Rotational movement of the fluid may also be caused or enhanced by known means, e.g. by use of stirrers and/or electro-magnetically driven “fleas”. In the preferred embodiments of the third aspect of the present invention, rotational movement is brought about at least in part using suitably disposed guide means adapted to direct the lower level of an incoming flow of oil and water into a rotational path so as to impart a rotational movement to the remainder of the flow by a drag effect. Such means may function either with or without the assistance provided by tangential entry of the fluid flow.

Oil and water that is fed to a vortex chamber by the use of a conventional pump will, in the ordinary course of events flow through the vortex chamber inlet as a random mixture.

On the other hand, the vortex chamber may receive a two layer liquid flow through the inlet, being a discrete floating layer of oil supported by a layer of water.

This will be the case:

i. following upstream stabilisation during which the oil and water is allowed to flow gently along extended channels or conduits so as to allow oil time to separate out as buoyant droplets which rise to the surface of the water. Submerged corrugated separator plates, and, in particular, submerged “Lemer Plates” as defined below with their groove depths increasing along the longitudinal direction of flow may be disposed within the channels or conduits to promote the separation of the oil;

ii. during Marine Applications of the third aspect of the present invention.

When using means other than tangential entry to generate or enhance rotation of the fluid mass within the vortex chamber, it is preferred that such means operate

(a) below the level of the interface between the incoming oil and water layers in cases coming under i or ii above, and

(b) in other cases, below the level of the oil/water interface after a floating layer of accumulated oil has been formed following upward migration of dispersed oil, as the case may be, and

(c) in every case, below the level of the oil vortex when and after it is formed.

It is common practice to convert a naturally occurring or artificially generated liquid stream into a rotating fluid mass by introducing the stream into a vortex chamber by way of tangential entry. The term “vortex chamber” is used herein to designate a vessel or enclosure that contains or that is adapted to contain a vortex. The term “vortex” shall bear its ordinary primary dictionary meaning, i.e. “vortex: mass of whirling fluid”.

According to a fourth aspect of the present invention there is provided a vortex chamber in the form of or comprising a device adapted to convert a flow of liquid entering the chamber into a vortex where the device includes a wall member having the configuration of a helix when seen in plan view that stands on a base member and defines a helical path of progressively diminishing radius adapted to receive the flow or a layer of the flow and guide the same along the said path to the zone around the centre of the helix, such zone comprising liquid outlet means passing through the base member.

Seen from above, the helical wall member resembles an unwound spiral clock spring, the inner end of which stops short of the geometrical centre of the helix and preferably stops short of the outlet means. For the purposes of this specification, and for convenience, a device as defined in accordance with the fourth aspect of the invention which may be

i. comprised within a chamber so that it becomes a vortex chamber, or

ii. a vortex chamber in its own right is referred to herein as a “Clock Spring Guide”.

The Clock Spring Guide may be used within a vortex chamber acting in conjunction with tangential entry means. In such a case, it provides additional rotational impetus to the liquid or to a layer of the liquid which enters the helical path over and above tangential entry alone. Alternatively, the Clock Spring Guide may be disposed within a vortex chamber to receive the liquid flow as it enters so that the liquid flow does not impinge against the chamber wall.

During operation, the entire flow may pass through the mouth of the helix arid along the helical path towards the centre zone, e.g. where the Clock Spring Guide is used as or forms part of a stabilising chamber as mentioned below. Alternatively, a layer (and in practice, the lower layer) of the flow passes through the mouth of the helix and along the helical path. In doing so, the layer exerts a drag effect upon the remainder of the flow so that all of the flow is converted into a vortex. This is the preferred mode of operation when the fourth aspect of the invention is applied to the separation of oil and water.

The Clock Spring Guide provides the following practical advantages:

1. It can be adapted to act selectively at any level of a liquid flow. In practice, it is employed to act on the lower layer of the flow. In a process for the separation of oil from water, and in particular floating oil, the best results are secured where the helical wall is adapted to act on the underlying layer of water. The primary vortex thus generated exerts a drag effect upon the overlying water so that it becomes the upper part of the water vortex. This in turn exerts a smooth drag effect upon the floating oil over the whole area of the oil/water interface to give a stable, non-turbulent oil vortex.

2. It provides an effective means for generating a vortex in circumstances where it may be difficult, expensive or impractical to provide a tangential entry into a vortex chamber. It can be used in conjunction with a direct entry port. A direct entry port is, in general, easier to make and seal than a tangential entry port.

3. It acts to dampen down turbulence, pulsations, vibrations and other disruptive elements accompanying the liquid flow at the inlet. As a result, it can provide a smoother and more regular vortex than that provided by tangential entry alone or by mechanical stirring.

4. It is highly effective in converting a unidirectional liquid flow into a vortex having a relatively high angular velocity. It can provide A “conversion ratio” of vortex angular velocity to inlet unidirectional flow speed that is higher, and that can be substantially higher than the conversion ratio provided by tangential entry alone.

5. It may be adapted to form a vortex chamber in its own right. The device so adapted is referred to below as the “Independent Clock Spring Guide”.

6. By varying the characteristics of the helical wall member, including its height, the contour of the upper rim and the tightness of the coils of the helix, the characteristics (including speed of rotation) of the vortex or of different parts of the vortex that is generated may be varied.

The fourth aspect of the present invention in its broadest scope provides, but is not limited to two particular applications of the Clock Spring Guide:

A. The separation of liquids of different densities exemplified by oil and water, and

B. The stabilisation of a liquid flow.

A. Oil/Water Separation.

According to the first application, there is provided a vortex chamber for the purpose of and a method of separating oil from water.

The vortex chamber in question consists of a vortex chamber as set out above that is adapted to receive a flow of oil and water entering the chamber and comprising means for the removal of oil from a discrete floating oil vortex formed within the chamber. Other significant features of the vortex chamber of the invention are referred to below

The method of separating oil from water makes use of a vortex chamber according to the fourth aspect of the present invention and includes the steps of

a) directing a flow or a component part of a flow of oil and water along the helical path defined by the helical wall member so as to transform the flow into a whirling fluid mass within which oil floats as a discrete oil vortex buoyantly supported by whirling water;

b) withdrawing oil from the oil vortex; and

c) permitting water to escape through the liquid outlet means passing through the base member.

In the course of the oil separation operation, oil within the oil/water feed mixture on encountering the whirling fluid mass floats upwardly to the water surface to form a floating layer of oil. Alternatively, if the oil encounters the whirling fluid mass whilst floating on water, it will remain as a floating layer. As the oil/water feed mixture flow continues, water flows downwardly through the vortex chamber and out through the outlet in the base member. The continued flow of the water, at least part of which flows along the helical path perpetuates the existence of the whirling mass of water that supports and provides rotational impetus to the floating oil which becomes a discrete vortex.

As the oil/water feed mixture flow continues, the amount of oil floating on the water surface increases. The oil vortex assumes a shape which may loosely be described as an inverted rotating “bell curve” shape. The thickness or depth of the floating oil layer is greatest at the centre of the oil vortex. The measure of such thickness or depth will turn on the quantity of oil in the vortex and the rate at which the vortex rotates.

When the oil vortex has attained its desired size, oil is withdrawn at a rate that is dependent upon the rate of accretion of additional oil from the oil/water feed mixture flow. The thickness or depth of the oil vortex will increase with an increase in the speed of rotation up to a critical speed of rotation beyond which the inverted bell configuration is impaired or lost as oil breaks off the lower part of the vortex. It is therefore important to limit the speed of rotation so that it does not arrive at such critical speed. One or more centrally disposed horizontal baffle plates located below the oil/water interface will serve to counter the tendency of the oil to break away from the bottom of the oil vortex and promote the oil vortex's integrity.

The oil may be withdrawn from the oil vortex in the first place using an oil removal pipe having its inlet immersed within the oil vortex. A centrally disposed oil removal pipe that extends downwardly from its inlet may usefully support the baffle plate or plates. Under stable conditions, the shape of the oil vortex provides a deep a reliable reservoir of oil for the oil removal pipe inlet in which the inlet may be reliably maintained above the oil/water interface. The shape assumed by the oil vortex also provides an advantage when operating under unquiet conditions, e.g. where outside wave motion causes fluctuation in the fluid surface level in the region of or above the mouth of the helix or results in uncontrolled movement of the Clock Spring Guide's support or mounting. To the extent of its depth in any particular case, the inverted bell curve shape of the oil vortex affords protection against entry of water through the inlet of a downwardly or upwardly extending oil removal pipe on the one hand and “gulping” of air from the above surface of the oil vortex on the other hand.

Oil withdrawal at the oil vortex surface by the use of the “Density Differential” principle. When a layer of oil floats on water, the fluid surface level is elevated. This phenomenon is a necessary consequence of the difference in the density as between oil and water. By “fluid surface level” is meant the uppermost liquid surface level at any point. Thus when water only is present, the fluid surface level will be the surface level of the water. But when a layer of oil floats on the water, the fluid surface level will be the surface level of the oil. Since the specific gravity of floating oil is less than that of the underlying water, it follows that the volume of floating oil required to displace a given volume of water will be greater than the volume of the water displaced. The thicker the layer of the floating oil, the more will its surface be elevated. Where it is desired to take advantage of this phenomenon (referred to herein as the “Density Differential” principle), the inlet rim of a downwardly extending oil removal pipe adapted to remove oil from an oil vortex is located at a level that stands proud of the fluid surface level when water alone is present. When an oil vortex is formed and more oil is accumulated within the oil vortex its thickness increases. Hence the fluid surface level of the oil rises. If and when it rises above the level of the inlet rim, oil flows into the inlet and out through the oil removal pipe. In practice, the “Density Differential” principle has its main application where the Clock Spring Guide is provided with a stable or relatively stable base or mounting. The principle may also be applied using the inlet rim, located at the same level, of an oil removal pipe that extends upwardly with continuous suction applied at the inlet.

Shape and Vertical Disposition of the Upper Rim of the Helical Wall Member: Where the Clock Spring Guide is intended for the separation of oil from water, it is preferred that the level of the upper rim of the helical wall guide be progressively lowered in the direction of the centre of the helix. Ideally, the path traced by such upper rim will be located away from the interface between the oil vortex and the supporting water, but will follow the contour of the nearest point on the interface. The best results are attained where the oil vortex does not extend downwardly as far as the upper rim of the helical wall member at any point.

Independent Clock Spring Guide:

With suitable configuration of the helical wall member, the Clock Spring Guide may be used in oil/water separation operations alone as a vortex chamber in its own right rather than as a device that is included within a vortex chamber. For this purpose, the upper rim of that part of the helical wall member that constitutes the outer circumferential whorl or coil of the helix is adapted so as to stand proud of the fluid surface level of the incoming oil/water feed mixture flow and/or any other external fluid surface level during operation. So is that part of the upper rim of the first inner whorl or coil that is in the vicinity of the mouth of the helix. A barrier plate spans the lower part of the gap between the outer whorl or coil and the first inner whorl or coil at or in the vicinity of the mouth of the helix. The barrier plate extends from the base member to a height that results in an inlet between the outer and first inner coils that permits admission of oil and a supporting layer of surface water into the device. Downstream of the inlet, the lower layer of the water enters the helical path defined by the wall member, and a primary vortex is formed. The overlying water becomes part of the overall water vortex, and the floating oil forms a separate inverted bell shaped vortex. Also downstream of the inlet, the height of the helical wall member rim decreases towards the centre at a rate that will ensure minimal disruption of the oil/water interface when the oil vortex is formed.

The Clock Spring Guide may be used in apparatus designed to remove surface oil floating on a body of water. For this purpose, the Clock Spring Guide may be partially immersed in the water and provided with buoyant or other support means to hold it at a level which allows floating oil and a supporting surface layer of water to enter:

i. through the inlet of a vortex chamber housing a Clock Spring Guide or, alternatively

ii. directly into an Independent Clock Spring Guide device through the inlet above the barrier plate at or near the mouth of the helix.

In either case, the arrangement may be held or moved forwardly relative to oncoming surface oil bearing water. A pair of forwardly extending divergent boom arms may be used to direct the oil and a supporting layer of water to the inlet. Thus, for example, the arrangement may be anchored facing upstream so that a downward flow of floating oil and its supporting layer of water are trapped by the boom arms and fed into the relevant inlet.

In another arrangement, one or more Independent Clock Spring Guide devices may be attached to the upstream side of a floating boom that extends across a river or tidal flow or some other moving body of water contaminated with floating oil, the boom extending at an angle to the direction of flow. Each such device is attached at an appropriate level in relation to the outside surface fluid level with the mouth of the helix facing the flow (or the re-directed flow) and with the side wall of the helical wall member at the mouth of the helix resting against the side of the boom. Floatation means together with seating means and/or tie strings connected to the boom ensure the stability of the device. Surface oil bearing water is re-directed by the boom to the inlets of the devices within which the relevant water and floating oil vortices are formed. Oil is removed from each oil vortex and may be transmitted through suitable piping along the boom to an onshore storage unit, or else may be fed directly into storage bags located in and supported by the body of water.

In the application of a partially immersed Clock Spring Guide (whether Independent or otherwise) to the separation of floating oil from a body of water, it is advantageous to provide below the base outlet a downwardly extending outlet pipe provided with baffle or spiral means, e.g. a spiral inward wall projection that acts on the rotating water passing through the base outlet so as to impel it downwardly and out through the pipe outlet. This promotes the upstream inward flow of surface oil bearing water to replace the water being expelled.

Series Operation:

In a useful embodiment of the fourth aspect of the present invention, two or more devices defined in accordance with the fourth aspect of the present invention may be arranged to act in series on the oil contaminated water. According to this embodiment, the water emerging from the outlet of the first device in the series is arranged to flow downwardly and into the second device in the series located at a lower level than the first. The drop in level generates a flow which, on entering the second device, becomes a vortex in which oil that has survived passage through the first device floats as an inverted bell-curve shaped vortex on the rotating water. In the case of each device, as the thickness of the oil increases, the fluid surface level of the oil rises; and the oil may be withdrawn by the application of the “Density Differential” principle discussed above. This arrangement may be repeated mutatis mutandis using a third and fourth and further devices likewise linked in series. The amount of oil separating out will diminish with each successive device. Water from the last device in line may advantageously be passed through a known type of filter matrix widely used in oil/water separation devices, for example a filter matrix comprising matted polyurethane fibres or a polyurethane foam to entrap the oil that has survived passage through the successive Clock Spring Guide devices.

B. Liquid Flow Stabilisation.

According to a second application of the device according to the fourth aspect of the present invention, there is provided a method for stabilising a liquid flow by the dampening down and/or elimination of turbulence, pulsations and/or vibrations transmitted or carried by the flow in which the flow passes through a device defined in accordance with the present invention so as to emerge through its base outlet. The flow may, optionally, be subsequently passed through a chamber provided with one or more baffle plates disposed across the path of the flow.

This application is not intended for the separation of oil by the formation of an oil vortex. Hence it does not call for the lowering of the height of the helical wall member in the direction of the centre of the helix.

“Clock Spring Guide”

Thus the expression “Clock Spring Guide” is used herein to refer to a particularly effective guide means for effecting or enhancing fluid rotation within the vortex chamber, such as are defined in accordance with the fourth aspect of the invention. The Clock Spring Guide may be used in conjunction with other rotation inducing means, e.g. tangential entry. Alteratively, it may be used as the sole rotation inducing means, as in the case of a “frontal” non tangential entry of the oil and water.

Returning now to third aspect of the present invention:

Definition. The Clock Spring Guide is defined for the purposes of the third aspect of a device for converting a flow of liquid into a vortex in which a wall member in the form of a helix when seen in plan view stands on a base member so as to provide a helical path of progressively diminishing radius adapted to receive the flow or a selected layer of the flow and guide the same along the said path to the zone around the centre of the helix, such zone comprising liquid outlet means passing through the base member. Where the Clock Spring Guide is located within or constitutes part of a vortex chamber provided with tangential entry means disposed in the same direction as the helical path towards the centre of the helix, the first circuit of the helical path will in practice lie between the inner wall of the chamber and the outer whorl or coil of the helical wall member of the Clock Spring Guide.

Seen from above, the helical wall member resembles an unwound spiral clock spring the inner end of which stops short of the geometrical centre of the helix and preferably stops at or short of the outlet means. Hence the designation “Clock Spring Guide”. A Clock Spring Guide provides very effective, smooth acting means for converting a liquid flow into a vortex. It may be present within a vortex chamber acting in conjunction with tangential entry means. In such a case it provides additional rotational impetus to the liquid or to a layer of the liquid which enters the helical path over and above tangential entry alone. Alternatively, the Clock Spring Guide may be disposed within a vortex chamber to receive all or part of the liquid flow as it enters so that the same does not impinge against the chamber wall.

In operation, the whole or part of a liquid flow is guided along a helical path of diminishing radius to the zone around the centre of the helix. Where part only is thus guided, in practice, it constitutes the lower layer of the flow. As it passes along the helical path, such lower layer exerts a drag effect upon the remainder of the flow so that all the flow is transformed into a vortex.

When a Clock Spring Guide is used to generate an oil vortex in the separation of oil from water, it is preferred that the level of the upper rim of the helical wall guide be progressively lowered in the direction of the centre of the helix. This is done in order to accommodate the pendulous submerged portion of the oil vortex after it has been formed. Ideally, the path traced by such upper rim will be located away from the interface between the oil vortex and the supporting water, but will follow the contour of the nearest point on the interface. The best results are obtained where the oil vortex does not extend downwardly as far as the upper rim of the helical wall member at any point. The Clock Spring Guide may also be put to use independently so as to act as a vortex chamber in the manner described under the heading “Independent Clock Spring Guide” in the above description of the fourth aspect of the invention. In such a case, an inlet is provided at or near the mouth of the helix between the upper part of the helical wall member that constitutes the outer circumferential coil or whorl and the upper part of the first inner wall member coil or whorl. The inlet lies above a barrier plate that spans the gap between the outer and first inner wall member coils or whorls at or near to the mouth of the helix and extends downwardly to the base member. The height of the barrier plate determines the height of the inlet above the base. Oil and water may be fed into the device through the inlet. The device may also be used to separate floating oil. To this end, it is immersed in a surface oil contaminated body of water to a depth that permits the admission of a flow of oil and a supporting layer of surface water through the inlet. Downstream of the inlet, an underlying layer of the water enters the helical path defined by the wall member, and a primary vortex is formed leading to the formation of the floating oil vortex as more oil/water feed mixture flows in. Care should be taken to ensure that the height of the helical wall member initially decreases along the direction towards the centre at a rate that will ensure minimal disruption at the oil/water interface when the oil vortex is formed.

The Clock Spring Guide provides the following practical advantages:

(a) It can be adapted to act selectively at any level of a liquid flow. In practice, and when used in an oil separation process, the best results are secured where the helical wall is adapted to act on the underlying layer of water. The primary vortex thus generated exerts a drag effect upon the overlying water so that it becomes the upper part of the water vortex. This in turn exerts a smooth drag effect upon the floating oil over the whole area of the oil/water interface to give a stable, non turbulent oil vortex.

(b) It provides an effective means for generating a vortex in circumstances where it may be difficult, expensive or impractical to provide a tangential entry into a vortex chamber. It can be used in conjunction with a direct entry port. A direct entry port is, in general, easier to make and seal than a tangential entry port.

(c) It acts to dampen down turbulence, pulsations, vibrations and other disruptive elements that may accompany the liquid flow at the inlet. As a result, it provides a smoother and more regular rotating fluid mass than that provides by tangential entry alone or by mechanical stirring. This property is put to good effect in the separate use of a Clock Spring Guide as the principal operative element in a method for stabilising a liquid flow by the dampening down and/or elimination of turbulence, pulsations and/or vibrations transmitted or carried by the flow.

(d) It provides a very effective method of converting a fluid flow into a rotating fluid mass of relatively high angular velocity, giving a substantially higher “conversion ratio” of angular velocity of the mass to inlet flow speed than tangential entry alone.

(e) It provides an effective alternative to tangential entry where difficulties of cost or design associated with the provision of tangential entry are to be avoided.

(f) By varying the characteristics of the helical wall member, including its height, the contour of its upper rim and the tightness of the coils of the helix, the characteristics (including speed of rotation) of the vortex or of different parts of the vortex that is generated may be varied.

Removal of Oil from the Oil Vortex.

As the oil/water feed continues to enter the vortex chamber, additional oil accrues to the floating oil vortex which remains in the chamber. The oil vortex is supported by the continuous stream of water that flows between the inlet and the vortex chamber water outlet. Where use is made of the Clock Spring Guide as the vortex begetter, the outlet means passing through its base member will constitute the vortex chamber water outlet. When the oil vortex, however begotten, has attained its desired size, oil is withdrawn at a rate that is dependent upon the rate of accretion of additional oil from the oil/water feed flow. The thickness or depth of the oil vortex will increase with an increase in its speed of rotation up to a critical speed of rotation beyond which its inverted bell-curve configuration is impaired or lost as oil breaks off the lower part of the vortex. It is therefore important to limit the speed of rotation so as not to arrive at such a critical speed. In the context of the present invention, this is done by limiting the rate of flow of water through the vortex chamber. The speed of rotation of the oil vortex and that of the surrounding swirling water is dependent upon such a rate of flow. Means A as defined above will regulate the rate of flow, either acting alone or as influenced where relevant by Means B and/or to a limited extent, Means C and/or Means D.

A centrally disposed horizontal baffle plate located below the oil/water interface can be used to counter the tendency of the oil to break away from the bottom of the oil vortex and promote the oil vortex's integrity. Also as a precautionary measure, there may be provided, in addition, small supplementary and preferably symmetrically disposed outlet apertures at or near the periphery of the base member of the vortex chamber to take away some of the peripheral swirling water that tends to encourage oil to break away from the oil/water interface around the lower parts of the oil vortex.

The oil may be removed from the oil vortex through an oil removal pipe having its inlet immersed within or at the surface (see below) of the oil vortex. Removal may be upwardly by way of suction or downwardly by way of gravity. For upward removal, the inlet of the oil removal pipe may be dipped into a cup shaped sump immersed within the oil vortex. In general, however, removal is preferably effected downwardly by way of a centrally disposed oil removal pipe that extends downwardly from the inlet and which may usefully support the centrally disposed horizontal baffle plate.

Under stable conditions, the shape of the oil vortex ensures a reliable supply of oil from a deep and turbulence free reservoir of oil that surrounds the oil removal pipe inlet.

The shape assumed by the oil vortex also provides an advantage when operating under unquiet conditions, e.g. where outside wave motion results in uncontrolled movement of the support or mounting of the apparatus and in fluctuations in the fluid surface level within the vortex chamber. To the extent of the depth of the vortex in any particular case, protection is afforded against fluctuations that would result in the entry of water.

Removal of Oil by Application of the “Density Differential” Principle.

When a layer of oil floats on water, the fluid surface level is elevated. This phenomenon is a necessary consequence of the difference in the density as between oil and water. Since the density of floating oil is less than that of water, it follows that the volume of floating oil required to displace a given volume of water will be greater than the volume of water displaced. The thicker the layer of the floating oil, the more will its surface be elevated. Advantage is taken of this phenomenon (referred to herein as the “Density Differential” principle) by setting the fluid surface level within the vortex chamber when water alone flows through the chamber at an appropriate level below the inlet rim of a centrally disposed and downwardly extending oil removal pipe. When an oil/water feed flow enters the chamber, a floating oil vortex is formed around the inlet. As more oil/water feed enters, the more oil accumulates within the oil vortex. Its thickness increases. The fluid surface level of the oil rises. Where the original water surface level has been appropriately set, the surface level of the oil will rise above the level of the rim. Oil will flow into the inlet and out through the oil removal pipe for collection and storage.

Removal in Practice

When using a downstream weir acting valve as the downstream Means A to regulate the fluid surface level within the vortex chamber, the “Density Differential” principle for the removal of oil is applied by establishing the appropriate difference in level between the oil removal inlet rim within the chamber and the level of the weir rim of the downstream valve. The inlet means themselves may conveniently be constituted by one or more lateral slots in an upwardly disposed pipe. It may be convenient to make the level of the inlet rim adjustable, e.g. by telescopic mounting of the inlet or its support on to the oil removal pipe. The fluid surface level in the vortex chamber is regulated by the weir rim level of the downstream valve. In practice, to establish the correct final settings for oil removal, the downstream weir rim is initially set to provide a relatively low fluid surface level within the vortex chamber with water alone flowing through it. Such surface level will be below the anticipated eventual working level of the water surface. A stream of oil/water feed is then fed into the vortex chamber. An oil vortex is formed. It is allowed to accumulate oil and grow to the desired size. At this stage, its surface will lie below the oil removal inlet rim. The downstream weir rim level is adjusted so as to raise the fluid surface level within the vortex chamber to the point where the oil vortex surface level arrives at the level of oil removal inlet rim. That provides the permanent setting for the downstream valve. As more oil from the oil/water feed accrues to the oil vortex from the incoming oil/water feed stream, oil simultaneously flows over the oil removal inlet rim and out of the chamber of its own accord for collection and storage.

The preferred downstream weir acting valve means for putting the “Density Differential” principle into effect is a Tulip Valve.

Means A provides direct regulation of the appropriate surface fluid level within the vortex chamber for the application of the “Density Differential” method of the removal of oil from the chamber according to the third aspect of the present invention. Means B provides indirect regulation and can operate independently of Means A. Means C and Means D, by regulating the outflow and inflow respectively of the oil will influence the amount of oil in the oil vortex and hence its fluid surface level within the vortex chamber. The operation of each of the Means can have a bearing upon the operation of others. For example, if Means B were used to contribute to the regulation by Means A of the flow of water through the vortex chamber, the relevant weir valve rim settings to be adjusted as against the setting of the oil removal inlet rim would include the setting of the valve means arranged to regulate the flow of water through the by-pass means. As a general rule, when the broad scope of the application of the “Density Differential” principle falls to be considered, account will have to be taken of each of Means A to D when and insofar as they are put to use.

The description below refers to the use of Tulip Valves as performing the functions of Means A, Means B and/or Means C in the several aspects of the method of the present invention. It will be understood that, where the context so admits, such description will apply also, mutatis mutandis to the use of other valve means as already referred to above. However, such other valve means do not provide the peculiar advantages that result from the use of a Tulip Valve as defined in accordance with the first aspect of the invention.

The use of a Tulip Valve as a downstream Means A that regulates the rate of flow of water through the vortex chamber provides significant advantages in terms of reliability, accuracy and ease of operation when setting and adjusting the fluid surface level within the vortex chamber. With stable mounting of the apparatus of the invention, a Tulip Valve will also provide the preferred form of each of Means B and Means C (i.e. regulation of by-pass flow and the flow of oil from the oil vortex respectively).

The embodiment of the third aspect of the present invention that makes use of the “Density Differential” principle in the removal of residual oil retained by the water flowing out of the vortex chamber using a tilted plate separation device is described below. It employs the same Means A to regulate the fluid surface levels both within the vortex chamber and the separation device. The Tulip valve as defined in accordance with the first aspect of the invention is ideally suited for this purpose.

By-Pass Flow Regulation Means. Means B.

In the embodiment of the third aspect of the present invention wherein the oil enters the vortex chamber as a discrete layer floating on a layer of water, the water and oil are arranged to flow initially through a forward part of the apparatus located upstream of the vortex chamber inlet. Such forward part comprises a base member. During operation, the fluid surface level of the incoming flow at the inlet to the vortex chamber should be maintained at a constant level so far as circumstances permit. That is, so far as possible, a constant depth of fluid above the base member of the forward part should be maintained at the inlet. To this end, the present invention provides for by-pass means to divert water from the lower part of the water as it flows through the forward part of the apparatus.

This water is diverted away from the vortex chamber. Means B regulates the flow of the diverted water through the by-pass means.

The provision and regulation of by-pass flow means are of particular significance in Marine Applications of the third aspect of the present invention. For example, in one such Application, the apparatus of the third aspect of the invention may be buoyantly mounted for forward movement through an oil slick. The rate at which the oil bearing surface water enters the forward part of the apparatus will depend upon the forward speed of the apparatus. At higher speeds, oil bearing surface water will pile up in front of the vortex chamber inlet. The fluid surface level at the inlet will be elevated. The fluid surface level inside the vortex chamber will rise, resulting in what could become an excessive flow rate of water through the chamber. But at lower speeds, the fluid surface level at the inlet will be depressed. The result could be an insufficient flow of water to maintain a steady (oil vortex supporting) stream of water through the chamber between the inlet and the base outlet means.

In each case, the flow of water will be regulated by Means B. At the higher speeds, Means B will be adjusted so as to admit more water into the bypass conduit. At the lower speeds, it will be adjusted so as to admit less water into the conduit. With appropriate adjustments, there will be maintained as constant an outer fluid surface level at the vortex chamber inlet as may be reasonably possible. Hence there will also be maintained as constant a fluid surface level within the vortex chamber and, in consequence, as constant a flow through the chamber as may be reasonably possible.

During operation, a variation from one area to another in the thickness of an oil slick may call for a variation in forward speed and/or in the rate of flow through the by-pass means. The thicker layers of oil in the slick will call for slower forward speeds and/or an enlargement of the by-pass flow, and vice versa. The setting of Means B will be varied accordingly.

In general, when separating floating oil according to the third aspect of the present invention, variations

i. in the rate of flow of the feed stream into the apparatus of the invention and/or

ii. in the relative proportions of oil and water in the feed stream may be responded to in a controlled manner by the use of Means A and/or Means B.

In addition, Means C and Means D are available to deal respectively with variations in the rate of inflow of oil into the forward part of the apparatus and their consequences following either of the variations mentioned under i and ii above. Any one of several Means will influence the effect of any or all of the others when operated simultaneously. The by-pass means are advantageously constituted by one or more pipes or conduits. Their inlet or inlets are located in the forward part of the apparatus at the level of the lower layers of the incoming water and away from the floating oil/water interface. In Marine Applications, regulation of the rate of water flow through the by-pass means may be by the use of one or more submerged sluice gates set to operate at such inlets or at any point along the by-pass pipes or conduits. In other applications, weir acting sluice gates may be used. Particularly preferred in this context is the use of Tulip Valves.

Means for Regulating the Flow of Oil from the Floating Oil Vortex. Means C.

In the case of Means C, the oil removal pipe is connected to variable flow regulating means adapted to control the flow of oil from the oil vortex within the vortex chamber.

In this way, Means C can be used to control the surface level of the oil. Where the apparatus is provided with a stable base or mounting, and precise control is sought, the preferred Means C is a Tulip Valve. The surface level of the oil will in practice be the fluid surface level within the vortex chamber. This will influence the hydrodynamic pressure at the water outlet. Such pressure, in turn, will influence the rate of water flow through the outlet. Thus Means C may, indirectly, exert a regulating effect upon the rate of flow of water through the chamber.

It may be borne in mind that notwithstanding the maintenance of a constant fluid surface level for the floating oil vortex within the chamber, there will still be variation in the hydrodynamic pressure at the water outlet if the thickness of the floating layer is altered. This is a necessary consequence of the difference between the respective specific gravities of oil and water. In practice, such variation will be relatively minor and may for all practical purposes be ignored.

Means for Regulating the Flow of Oil into the Vortex Chamber. Means D.

Means D regulates the flow of floating oil into the vortex chamber and in practice is disposed across the upper part of the vortex chamber inlet. When all or part of the floating oil is denied entry, the underlying layers of the flowing water flow freely below the oil layer through the inlet. Means D may comprise a barrier plate the upper rim of which is arranged to span the inlet at an adjustable height so as to provide a weir rim that controls the entry of floating oil whilst its lower allows free flow of underlying water into the chamber. Alternatively, it may comprise a barrier plate adapted to be adjustably lowered into the incoming fluid stream to restrict the flow of floating oil carried by the water. During operation in this case, a relatively thick layer of oil is initially allowed to build up. The level of the lower rim of the barrier plate is then adjusted appropriately to allow entry of the oil into the vortex chamber at the desired rate.

The preferred form of Means D comprises a pivoted gate member adapted to open and close across the upper part of the vortex chamber inlet. The gate member is arranged to open inwardly into the vortex chamber in the same direction as the movement of the rotating fluid mass within the chamber. When the gate member opens, floating oil enters the vortex chamber together with its adjacent supporting layer of water. By closing the gate means either partially or wholly, the entry of the oil into the vortex chamber is restricted or prevented and a thickening layer of floating oil builds up against the pivoted gate member.

By regulating the rate of entry of the oil into the vortex chamber, the size and thickness of the floating oil vortex within the chamber may be regulated, subject to the imposition of a constant fluid surface level by the setting of the rim of the oil removal pipe inlet and/or the effect of Means C where the same is incorporated into the apparatus.

Where Means D comprises a pivotally mounted gate member, a horizontal baffle plate may advantageously be disposed across the inlet immediately below the gate member and adapted to extend in part into the interior of the vortex chamber with its underside at a level above the rotation imparting means. Such plate may be attached to the lower edge of the gate member. Its function is to provide an initial barrier between the oil bearing incoming flow and the rapidly rotating mass of water within the chamber and to minimise the setting up of disruptive flow patterns within the vortex chamber.

Static and Dynamic Marine Application.

In a useful embodiment of the invention according to the third aspect, the apparatus is buoyantly supported at a partly submerged level for static or dynamic oil separation activity.

In the case of static operation, the buoyantly supported apparatus is anchored or positioned to face upstream in a river or tidal flow and fitted with a pair of forwardly extending divergent booms to direct surface oil into the apparatus. It may also be used to separate oil that has been trapped by boom means extending across a river or tidal flow or the like and diverted to the forward part of the apparatus. In addition or as an alternative to a naturally occurring river or tidal flow, the apparatus may be adapted to supplement such a flow or to generate its own flow. To this end in each case, the apparatus is provided with rearwardly directed water propulsion means, for example a pump or an outboard motor marine screw propellor adapted to act upon the flow of decontaminated water when it emerges from the final exit pipe. The propulsion means may be located within the exit pipe, or downstream of the exit pipe outlet. Water that has flowed through the by-pass means may also be directed into the same exit pipe. The propulsion means generates or enhances a compensating flow of replacement water into the forward part of the apparatus, carrying with it a layer of floating oil. Variation in the power output of the propulsion means will result in a variation in the rate at which water flows through the vortex chamber. A conventional marine outboard motor can set up and maintain a very substantial flow of water during operation. By drawing a significant proportion of such a flow from the exit pipe, a significant throughput results, and surface contaminated water is drawn into the apparatus from a wide area.

In the case of dynamic operation, rearwardly directed water propulsion means mounted downstream of the decontaminated water exit pipe may be adapted to act to propel the buoyantly supported apparatus in a forward direction through a body of surface contaminated water. The propulsion means also promotes the flow of the surface contaminated water into the apparatus. Forwardly extending divergent boom arms are arranged to gather and direct the contaminated water into the forward part of the apparatus. The well known characteristics of a conventional marine outboard engine make it the preferred means both for controlled forward propulsion of the buoyant arrangement and for rearward propulsion of the decontaminated water.

Removal of Residual Oil.

In an important embodiment of the third aspect of the present invention, residual oil that has escaped capture within the vortex chamber is separated from the water that flows out of the vortex chamber outlet. In the working of this embodiment, simultaneous use is made of the same direct variable flow regulating means, Means A that is located downstream of the vortex chamber outlet both in relation to the initial vortex separation of the oil and water and in relation to the subsequent separation of the residual oil carried by the water following the initial separation.

Simultaneous separation of the residual oil is accomplished by the use of a Tilted Plate Separator interposed within the line of flow between the vortex chamber outlet and the Means A. The preferred form of the Means A is a Tulip Valve. The following description will apply, however, to the use of other appropriate flow control valves, mutatis mutandis, and especially to the use of weir acting sluice gates.

A Tilted Plate Separator as envisaged in this specification comprises one or a plurality of submerged tilted corrugated plates located in a separation chamber through which the partly decontaminated water flows from the vortex chamber outlet. The water carries with it the residue of oil that has not been separated out during the passage of the water through the vortex chamber. On entering the separation chamber, the partly decontaminated water impinges against the lower part of the downwardly facing corrugated surface or surfaces of one or more tilted corrugated plates. The flow continues along an upwardly inclined path in contact with such corrugated surface or surfaces. The upward flow may be a “cross-flow”, i.e. substantially at right angles to the direction of the corrugations as in the case of the CROSSPAK (T.M) Tilted Plate Separators. Preferably, the flow will be a “longitudinal flow” in the direction of the corrugations. The tilted corrugated plate or plates extend upwardly to below the level of the oil/water interface.

The fluid surface level within the separation chamber is regulated by the downstream Tulip Valve. The Tulip Valve simultaneously regulates the fluid surface level within the vortex chamber upstream. Within the separation chamber, the upward flow of the oil bearing water in contact with the downstream facing corrugated surface of the tilted plate or plates results in the coagulation of small particles of dispersed oil into droplets. When these attain a particular critical size, they break off at the top edge of each corrugated plate and float to the surface. Over a period of time, this leads to an accumulation of the oil droplets to form a layer of oil floating on water above the corrugated plates. The several zones wherein the oil droplets float to the surface and accumulate to form layers of floating oil are referred to herein as “surface accumulation zones”.

A separation chamber may comprise

(a) a single surface accumulation zone, as where a single corrugated plate or else a single “Stacked Plate” arrangement is employed to separate out the oil, or

(b) a plurality of surface accumulation zones, as where a plurality of discrete single corrugated plates and/or of “Stacked Plate” arrangements are so employed, e.g. in a “Serial Plate” arrangement.

Stacked Plate Arrangement and Serial Plate Arrangement.

A plurality of tilted corrugated plates may be arranged respectively as:

i. A “Stacked Plate” arrangement, and

ii. A “Serial Plate” arrangement which consists of

a. a series of single corrugated plates acting in sequence, or

b. a series of discrete units each comprising two or more such plates in a Stacked Plate arrangement acting in sequence, or

c. any combination of a and b.

Stacked Plate Arrangement.

In this case, two or more corrugated plates are arranged within a separation chamber in a stack of substantially parallel tilted plates. Within a stack of plates, one plate is located above and in close proximity to the next plate below. During operation, a stream of oil bearing water is arranged to flow upwardly in contact with the corrugated or grooved undersides of each of the plates. Coagulated oil in the form of buoyant oil droplets break off the top edges of the plates and rise to the surface accumulation zone above. In the case of known tilted plate oil separators, it is customary to use the Stacked Plate packs with the plates inclined at an angle of 45 degrees to the horizontal. This inclination is said to maximise the effect separation surface area. The expression “effective separation surface area” in this context relates to the horizontal component of the surface area of the inclined plates. Other angles of inclination can be effective, depending on the circumstances.

Serial Plate Arrangement.

In this case, the tilted corrugated plates are arranged so as to act in sequence to promote the separation of oil from water. The sequence maybe of single tilted corrugated plates. Alternatively, the sequence may include discrete tilted Stack Plate units of two or more corrugated plates disposed so as to act in sequence along the line of the fluid flow between the inlet and the outlet of the separation chamber. The area where the droplets of oil separated out by the first tilted corrugated plate or by the first Stacked Plate unit accumulate to form a floating layer of oil is referred to for the purpose of this specification as “the first surface accumulation zone”. A barrier extending downwardly from above the fluid surface isolates the first surface accumulation zone from a second corresponding like zone which receives oil from the second tilted plate or tilted Stacked Plate unit. Likewise, each successive like surface accumulation zone in sequence is isolated by a barrier from its preceding surface accumulation zone. The barrier in each case directs the flow of water down to the vicinity of the base of the separation chamber. The water takes with it the oil that has not been left behind in the previous surface accumulation zone. The fluids flow under the barrier and then upwardly in contact with the downwardly facing corrugations of the next corrugated plates or Stacked Plate unit as the case may be. Oil that is separated by such corrugated plate or Stacked Plate unit rises to the surface of the next surface accumulation zone. The sequence is repeated as many times as may be deemed necessary or desirable to achieve the required degree of separation. Oil in progressively diminishing amounts accumulates in the successive surface accumulation zones. It is removed in the manner indicated below. Oil depleted water flows out of the separation chamber from below the surface of the last surface accumulation zone. Such water may then be passed through a filter matrix of a known kind to entrap very finely divided oil particles that have survived passage through the separation chamber.

Recovery of Oil from the Separation Chamber.

During operation, surface oil accumulates in a continuously thickening layer within the several surface accumulation zones. It may be scooped out or sucked out by conventional means.

In the preferred method of this application of the third aspect of the present invention, the oil is removed by making use of the “Density Differential” principle mentioned above. Within the several surface accumulation zones, or within certain selected zones, there are located oil removal pipe inlets leading onto downwardly extending oil removal pipes. As in the case of the setting of the respective levels of the weir rim of the downstream Tulip Valve and the rim of the oil removal pipe inlet within the vortex chamber, the respective levels of the weir rim of the Tulip Valve and of each oil removal pipe inlet rim within the separation chamber are set so that when water alone flows through the separation chamber, each inlet rim stands proud of the water surface level. Each inlet rim is also set at a level that is low enough to allow the oil to rise above its level when the thickness of the layer of accumulated oil in its particular zone attains a particular value. The thickness of the respective oil layers increases and the oil surface levels rise when oil contaminated water flows through the separation chamber. Oil eventually flows over the rims of the respective inlets and down through the oil removal pipes. See also the discussion above under the heading “Removal in practice”.

During the operation of the Serial Tilted Plate type separator, the oil accumulates in successive surface accumulation zones at successively slower rates. Eventually, the rate of accumulation in one or more downstream zones may become negligible so that it becomes impractical to rely on the Density Differential principle for an outflow of oil. It may be preferable to use an oleophilic rag, sponge or swab to remove it.

Use of Oil Filters.

Water that has flowed through the separation chamber will carry with it traces of residual oil in the form of very finely divided particles that are resistant to coagulation into droplets. At this stage, further oil separation may be carried out by passing the water through an oil adsorbent matrix filter, e.g. a porous polyurethane foam or polyurethane matted fibre matrix of the kind widely used in oil/water separators. Preferably, this is done by way of downward flow.

In the absence of an intermediate Tilted Plate separation chamber, the partly decontaminated water that flows from the vortex chamber may be passed directly through such an oil adsorbent matrix filter. Many oill water separators in current use employ such matrix filters as the principal expedient whereby oil is separated from water. When the filters become saturated, they are re-constituted or replaced. This limits their utility where there is a high proportion of oil in the oil/water feed mixture. Steps have to be taken to recover the oil from the saturated filter matrices, and this inevitably involves effort and expense. On the other hand, when the method of the present invention is put to use, the filter matrix is called upon to deal with no more than

a. where a Tilted Plate separator is used as indicated herein, the nearly negligible amount of very finely divided oil carried by the water after its passage through the separation chamber, or

b. the residual oil present in the water flowing out of the vortex chamber where no intermediate Tilted Plate separator is used,

and the frequency and cost of replacing or reconstituting the filter matrices is materially reduced.

Use of “Lemer Plates”.

The third aspect of the present invention includes within its scope the optional and beneficial use of a Tilted Plate separator as described above in accordance with the second aspect of the present invention.

Such Tilted Plate separator comprises one or more of the particular corrugated or grooved plates which, in part, form the subject matter of the description in relation to the second aspect of the invention. For convenience, such plates are referred to herein as “Lemer Plates”.

Definition. A Lemer Plate is defined for the purposes of the third aspect of the invention as a corrugated plate for use in separating two masses of flowable matter having different specific gravities which comprises adjacent longitudinal grooves disposed between corresponding ridges, the depth of each groove being arranged to increase progressively simultaneously with a progressive decrease in the mean angle between the groove sides when proceeding along the one or other longitudinal direction.

For the purposes of this definition, the expression “the mean angle between the groove sides” means the angle between two lines, each extending upwardly from the same point on the base line of a groove, the one to the ridge line running along the ridge located on the one side of the groove and the other to the ridge line running along the ridge located on the other side of the groove, both lines as seen in plan view being disposed at right angles to the said base line.

The description relating to the second aspect of the invention indicates and identifies the preferred (but not essential) Tilted Plate separators incorporating corrugated plates to be interposed between the vortex chamber and the Means A (in particular, a Tulip Valve) for the removal of residual oil from the partly decontaminated water outflow from the vortex chamber in this embodiment of the third aspect of the present invention.

Upstream Stabilisation.

Reference has been made above to an upstream stabilisation of the oil and water feed mixture following which the oil and water flow into the vortex chamber, as two separate layers. Where there has been no stabilisation of this kind, and in cases other than Marine Applications, the manner of the sourcing and of the transference and/or delivery of an oil/water feed mixture to the vortex chamber can give rise to random irregularities in the rate of flow and to the transmission of disruptive elements within the flow. For example, direct pumping of an oil/water mixture can result in the transmission of turbulence, pulsations and/or vibrations which can be prejudicial to the formation of a stable and turbulence free floating oil vortex within the vortex chamber. The situation is aggravated when air is admixed with the oil/water mixture. Such admixture is inevitable when the oil/water feed is drawn from a surface oil skimmer such as the MANTIS (T.M) Skimmer described in our co-pending international patent application No. PCT/GB19/01327. In this and in other cases, it becomes desirable to stabilise the flow before it enters the vortex chamber.

The third aspect of the present invention in its broadest scope includes the optional and beneficial provision of upstream stabilisation means acting on the oil and water feed stream prior to its admission to the vortex chamber which includes:

i. a preliminary vortex chamber that contains flow diverting baffle or guide means that impart a rotational movement to the stream. In this connection, it is highly advantageous to make use of a Clock Spring Guide;

ii. optionally, a further chamber to receive the stream from the preliminary vortex chamber and which contains one or more baffle plates adapted to lie across the direction of flow of the stream.

By the use of such stabilisation means, turbulence, pulsations and vibrations within or transmitted by the oil/water feed stream are diminished or eliminated. The placated stream will enter the vortex chamber to provide a smooth and turbulence free oil vortex floating on the water.

Where the oil/water mixture is delivered by gravity flow alone, problems of the kind that are caused by an upstream pump seldom arise. The apparatus of the invention may be usually worked satisfactorily without the addition of an upstream stabilisation chamber.

The third aspect of the present invention also relates to a method in which each or any of the several embodiments of the apparatus of the third aspect of the invention as described herein is used to separate oil from water.

Algae Separation.

According to an important further realisation of the third aspect of the present invention, the apparatus as described herein may be used for the purpose of separating floating algae from water. In this connection, the description herein insofar as it relates to the separation of oil from water is repeated, where the context so admits, so that the expression “floating algae” may be substituted for the expression “oil” where it occurs.

Supplementary Tulip Valves and Sluice Gates.

In the case of any weir acting sluice gate referred to herein, including any Tulip Valve, there may be added to such a device one or a plurality of such devices all connected in parallel to the original source of liquid flow to the first device, but with the weir rim of the second and each subsequent device being set at a predetermined level that is marginally higher than the level of the weir rim of the preceding device in sequence. Such an arrangement provides means for accommodating unexpected or undesired surges in flow that might exceed the capacity of the first device or of the preceding devices in the sequence. In this connection, reference is made once again to the description relating to the first aspect of the invention.

Embodiments of the various aspects of the invention will now be described by way of examples only and with reference to the accompanying drawings, in which:

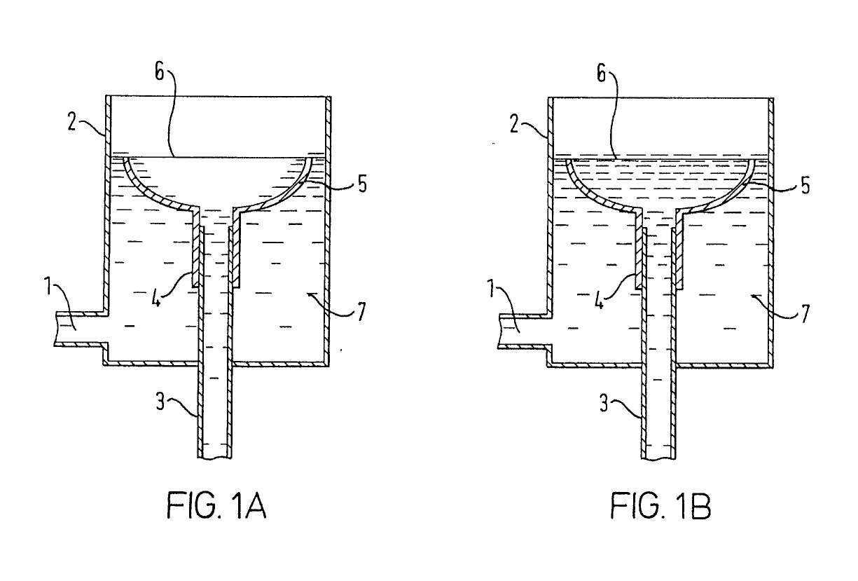

FIG. 1A is a schematic cross-sectional view of an embodiment of a weir valve according to the first aspect of the present invention, the weir valve being provided with a horizontal weir rim adapted to regulate the surface level of a body of water upstream and/or to regulate the rate of outflow from such body of water;

FIG. 1B is a schematic cross-sectional view of the weir valve of FIG. 1A, in which the direction of flow through the device is reversed;

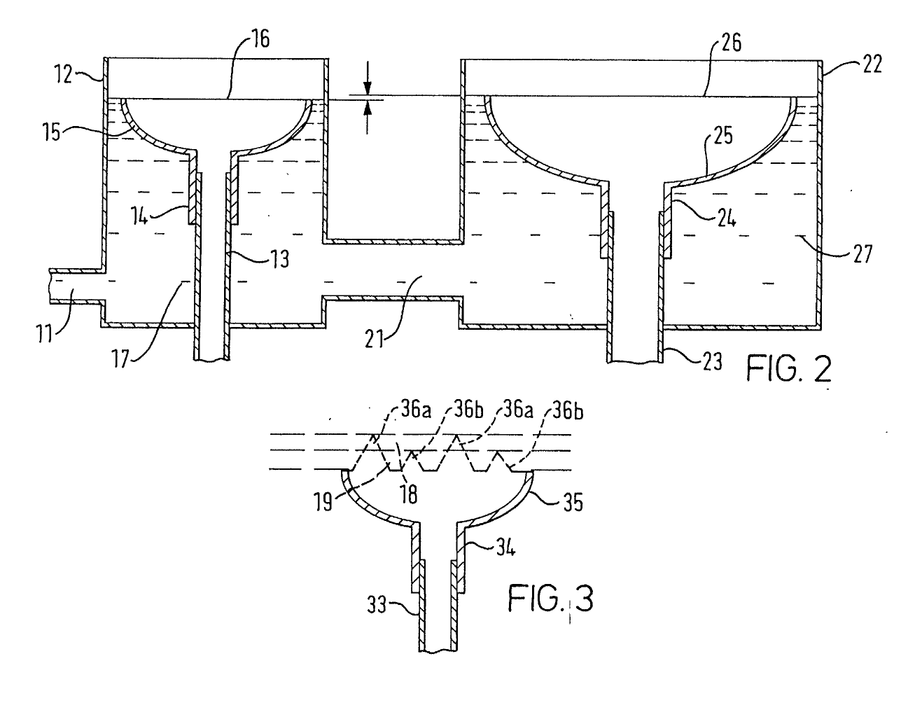

FIG. 2 is a schematic cross-sectional view of the weir valve of FIG. 1A which is connected to a second weir valve adapted to cope with sudden surges in the flow of the water that exceed the capacity of the first weir valve and could otherwise result in an undesired raising of the surface level of the body of water upstream;

FIG. 3 is a schematic cross-sectional view of a weir valve according to a second exemplary embodiment of the first aspect of the invention, a telescopically supported expanded pipe end bounded by a weir rim having triangular upward projections with trapezoidal apertures in between, the area of one or any of which below a horizontal plane representing a surface fluid level at any height above the lower end of the projections may readily be calculated as may the rate of change of such area with change in the height;

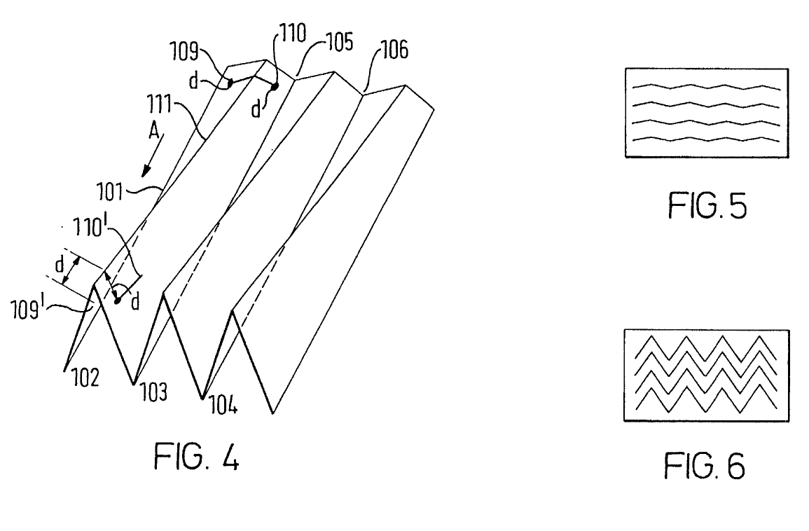

FIG. 4 is a perspective view of a corrugated plate with grooves according to an exemplary embodiment of the second aspect of the present invention;

FIG. 5 is a schematic end view of a Stacked Plate unit comprising a plurality of the plates of FIG. 4;

FIG. 6 is a schematic view of the opposite end of the Stacked Plate unit of FIG. 5;

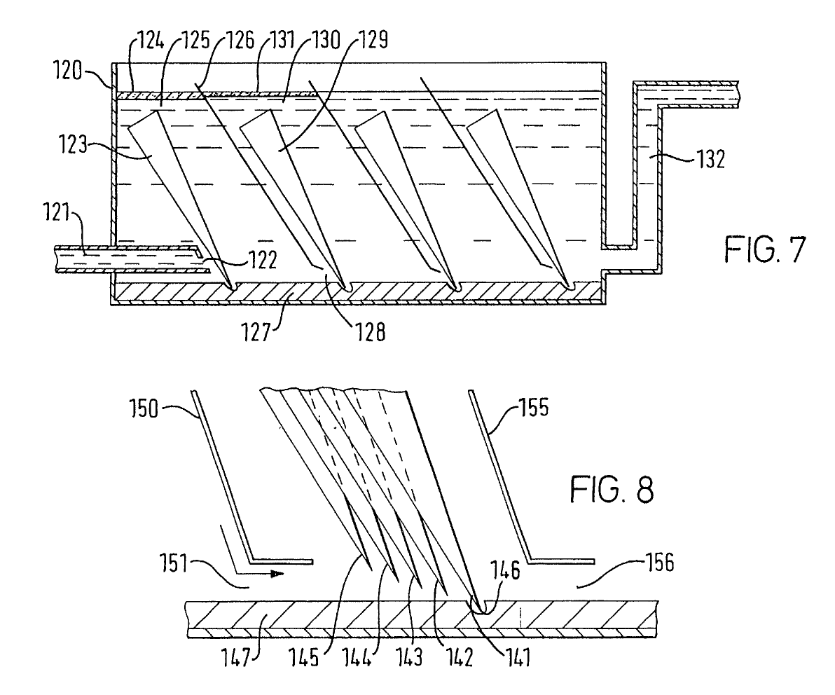

FIG. 7 is a schematic cross-sectional view of a separation chamber which houses a Serial Plate arrangement of discreet unitary grooved plates according to an exemplary embodiment of the second aspect of the invention and barrier plates disposed in series;

FIG. 8 is a schematic cross-sectional view of a unit in a modification of the arrangement of FIG. 7, whereby the Stacked Plate unit is substituted for one or more of the unitary grooved plates of FIG. 7;

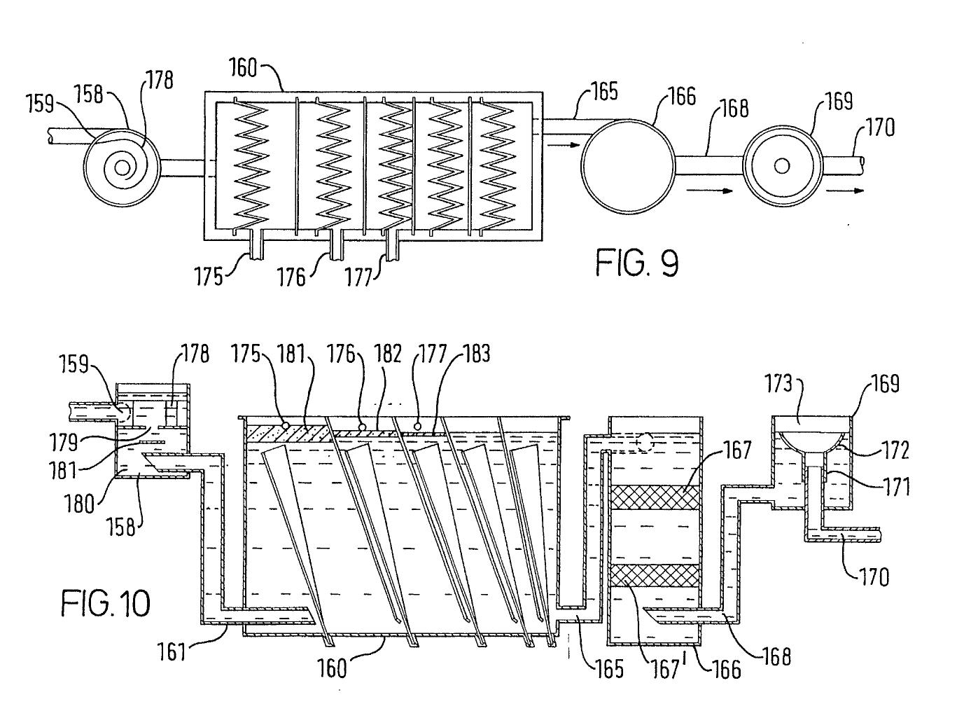

FIGS. 9 and 10 are side and partial plan views respectively of apparatus according to an exemplary embodiment of the second aspect of the present invention which includes, disposed in series:

i. An upstream stabilisation chamber;

ii. A separation chamber of the kind represented in FIG. 4 which includes means for the removal of oil pursuant to the application of the Density Differential principle;

iii. A filter chamber containing an oil filter matrix e.g. matted fibrous polyurethane or porous polyurethane foam adapted to separate out residual oil from water, and

iv. A Tulip Valve adapted to control the upstream rate of flow and/or the fluid surface levels within the separation chamber;

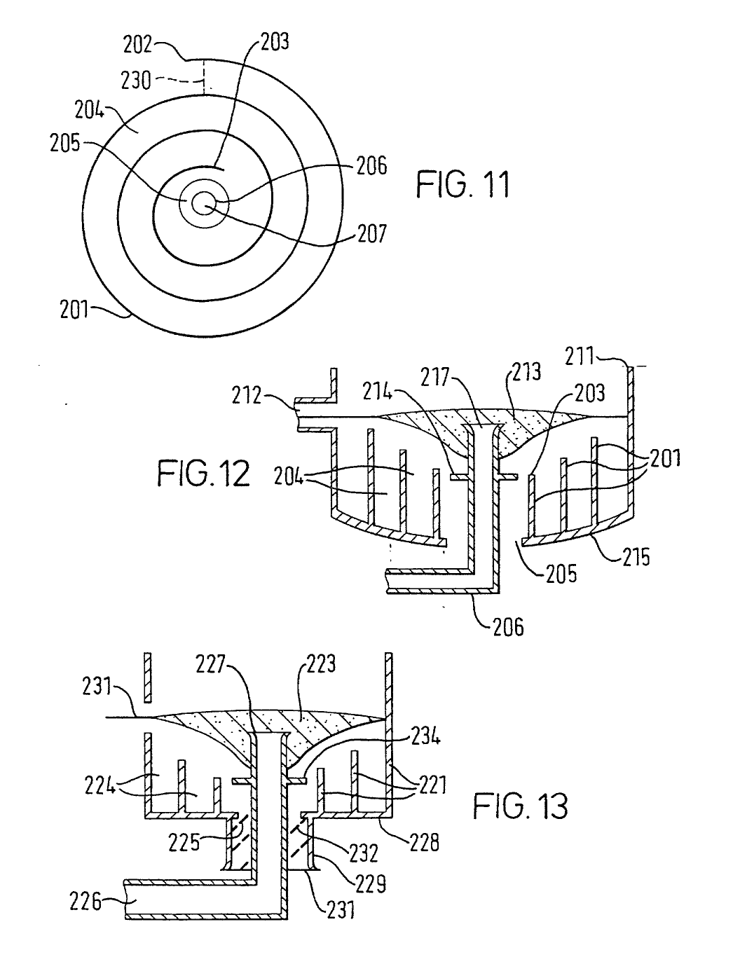

FIG. 11 is a plan view of the helical wall of a device according to the fourth aspect of the present invention in which the helical wall terminates at its inner end adjacent a centrally located liquid outlet aperture through which extends an oil removal pipe;

FIG. 12 is a side sectional view of the arrangement of FIG. 11, where the Clock Spring Guide is located within a vortex chamber and is adapted to impart rotational movement to the water that enters the helical path defined by the helical wall member;

FIG. 13 is a sectional side view of an Independent Clock Spring Guide, the base liquid outlet aperture of which is provided with a downwardly extending conduit;

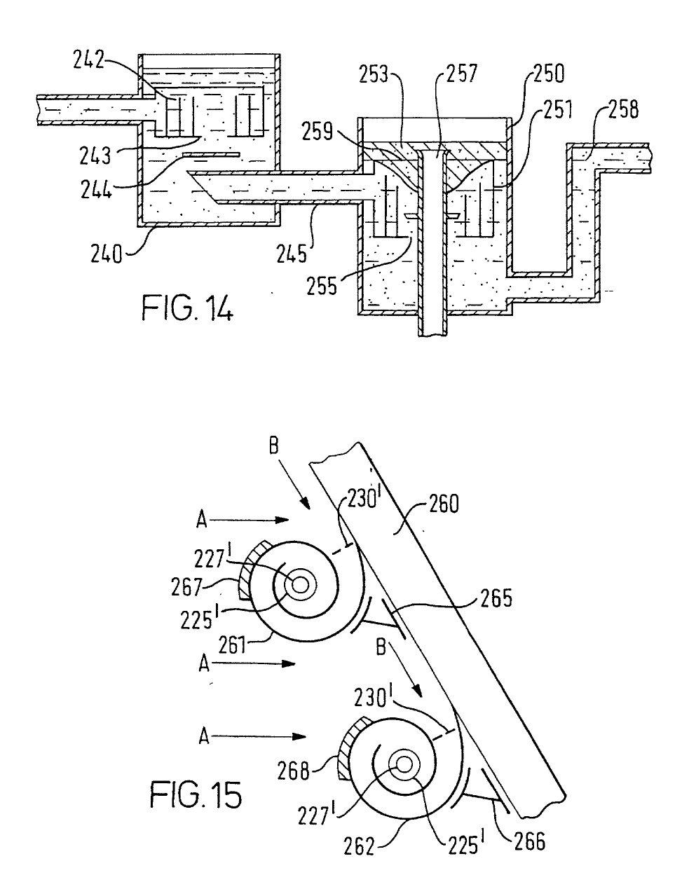

FIG. 14 is a Clock Spring Guide adapted for use in separating oil and water within a vortex chamber which receives an oil/water feed that has been stabilised by passage through a stabilising chamber which comprises a Clock Spring Guide;

FIG. 15 is a plan view of two buoyantly supported Independent Clock Spring Guide devices disposed to receive floating oil diverted by a boom that extends diagonally across a surface oil bearing tidal or river flow or the like;

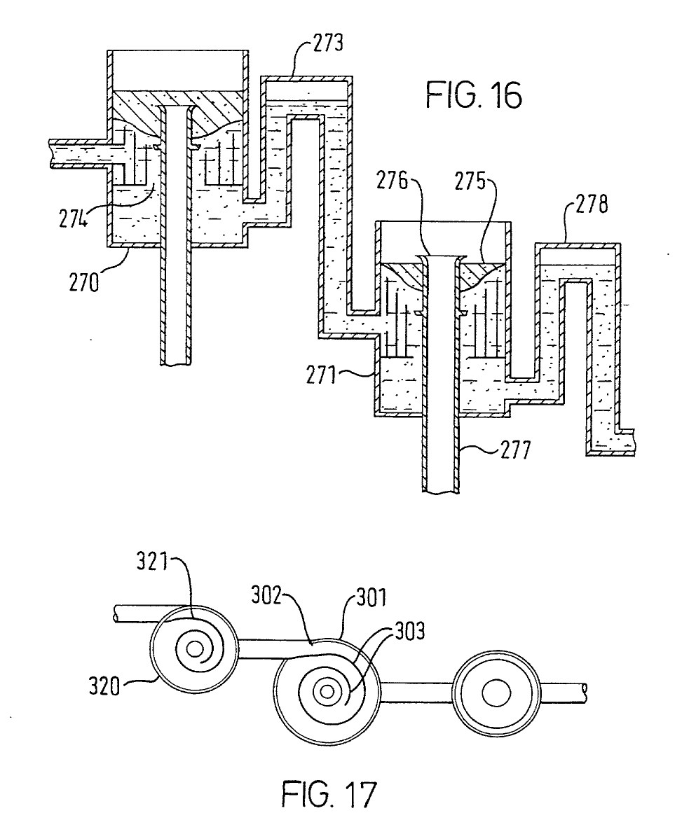

FIG. 16 is an arrangement in which two or more Clock Spring Guide devices according to the fourth aspect of the present invention are arranged to operate in series;

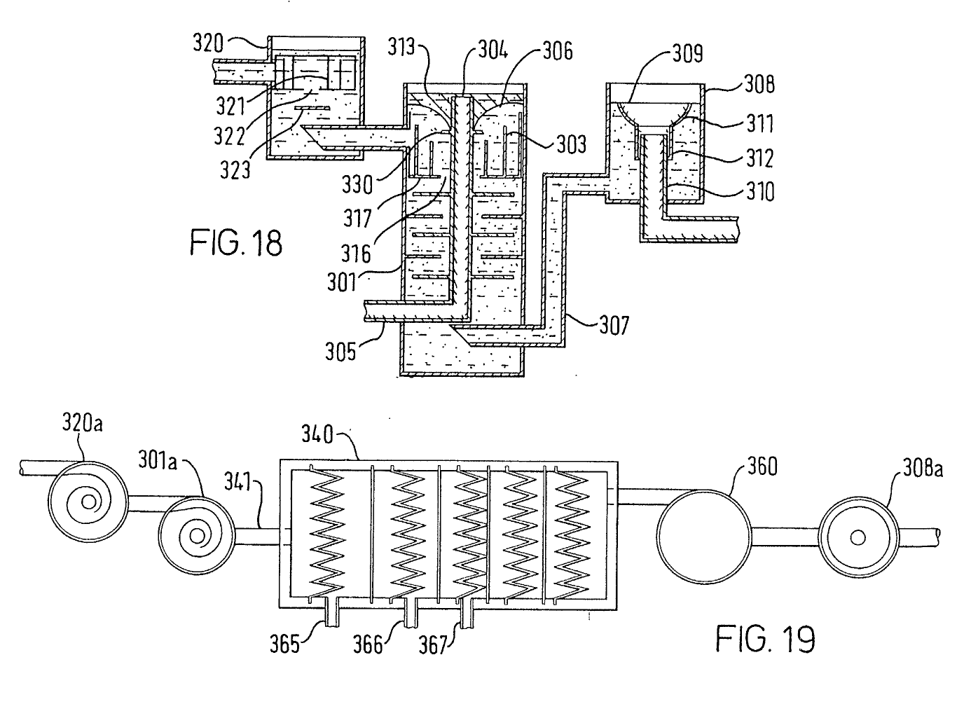

FIG. 17 and FIG. 18 are plan and cross-sectional side views respectively of a simple form of vortex oil separation system according to an exemplary embodiment of the third aspect of the invention;

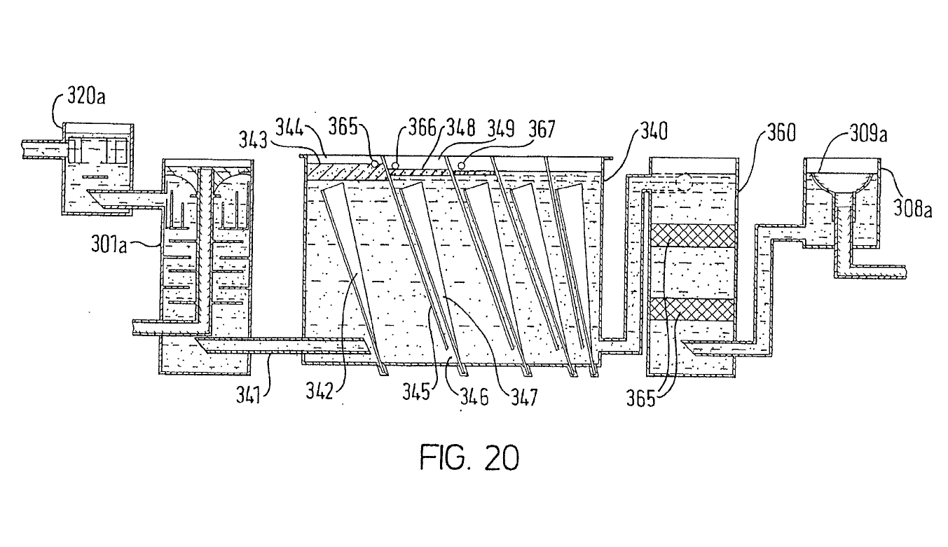

FIG. 19 and FIG. 20 are plan and cross-sectional side views respectively of another exemplary embodiment of the third aspect of the present invention, in which a tilted corrugated plate separation chamber and a filter matrix chamber are interposed between

i. the vortex chamber and

ii. the Tulip Valve that constitutes the variable flow regulating means adapted to regulate the rate of flow of water through the vortex chamber as represented in FIGS. 17 and 18.

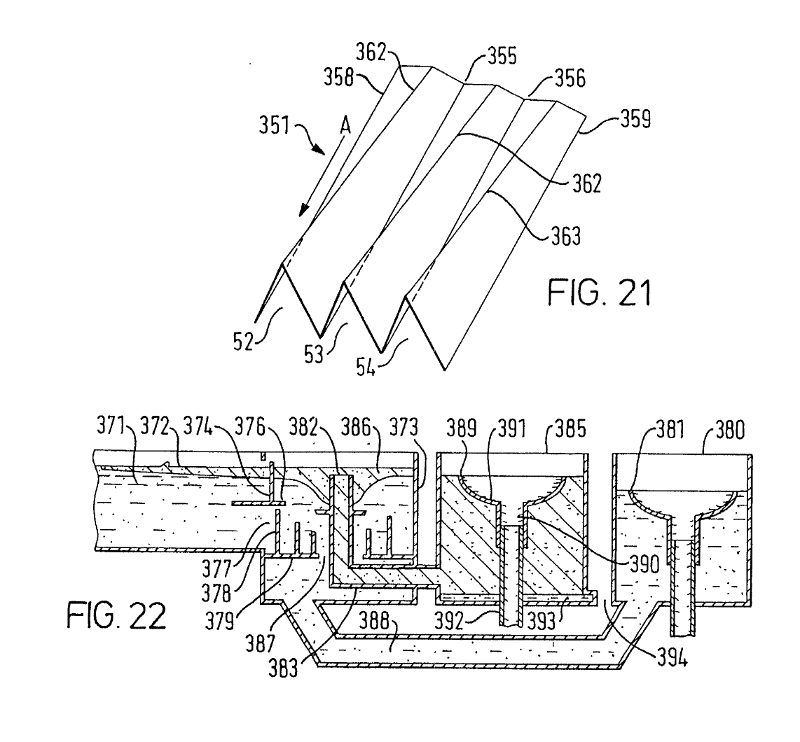

FIG. 21 is a perspective view of a “Lemer” corrugated plate for use in the tilted corrugated plate separator according to a preferred exemplary embodiment of the third aspect of the invention;

FIG. 22 is a sectional side view of apparatus according to yet another exemplary embodiment of the third aspect of the present invention, in which oil to be separated enters the vortex chamber as a discrete layer floating on water;

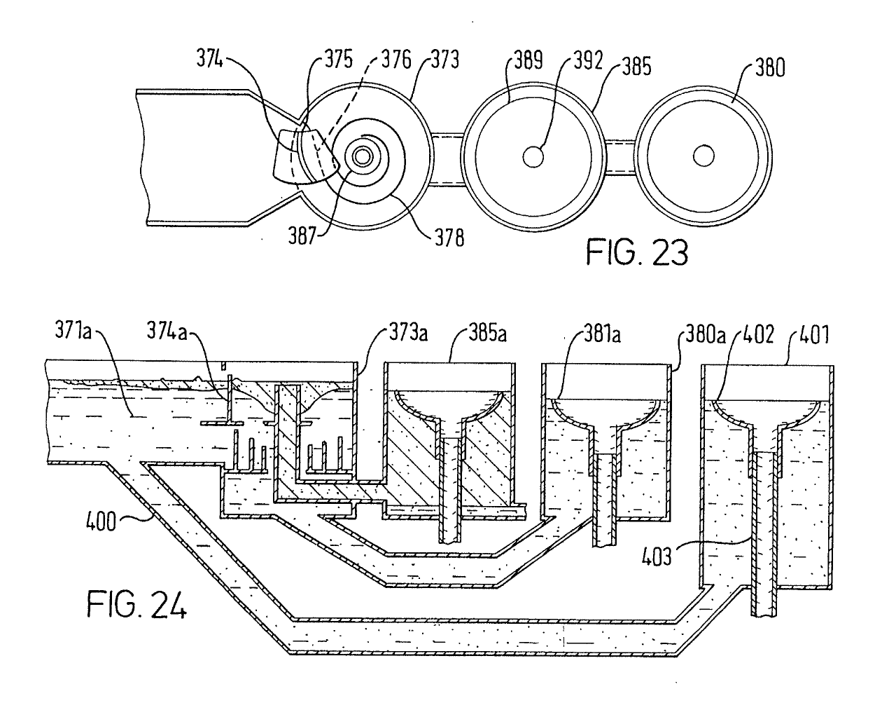

FIG. 23 is a plan view of the apparatus of FIG. 22;

FIG. 24 is a sectional side view of a modification of the apparatus of FIG. 22, which comprises by-pass means and weir valve means for controlling the flow of water through the by-pass;

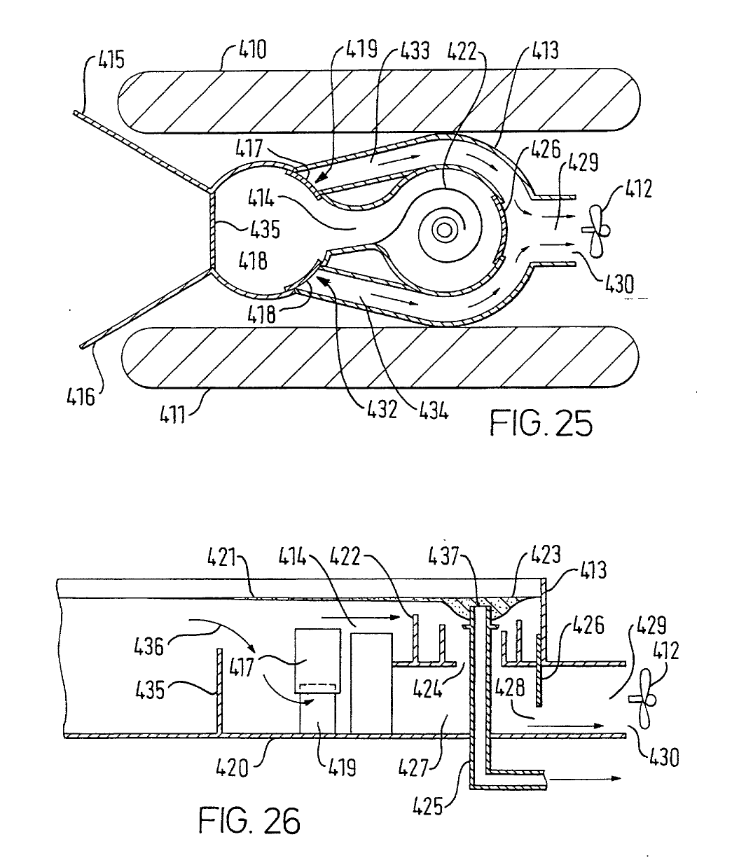

FIG. 25 is a plan view of a further exemplary embodiment of apparatus according to the third aspect of the present invention, which is mounted for buoyant support between a pair of parallel adjacent hulls, one on each side and is provided with a pair of forwardly extending divergent booms to divert floating oil and a layer of surface water into the forward part of the apparatus. Rearwardly directed water propelling means in the form of a marine screw propellor is provided behind final exit pipe for the water that has passed through the vortex chamber. By-pass conduits extend from the forward part of the apparatus upstream of the vortex chamber inlet to divert some of the water entering the forward part of the apparatus around the sides of the vortex chamber. Sluice gate valve means are provided to control respectively:

i. the rate of flow of water through the vortex chamber, and

ii. the rate of flow of water through the by-pass means; and

FIG. 26 is a sectional side view of the apparatus of FIG. 25.

Referring to FIG. 1A of the drawings a weir valve according to an exemplary embodiment of the first aspect of the invention comprises an inlet 1 which is connected to a body of water upstream and admits the water in through the lower part of a chamber 2 that is provided with an outlet pipe 3. Upwardly extending pipe 4 is telescopically mounted onto an upwardly extending part of pipe 3 and is provided at its upper end with an upwardly facing dish-shaped expanded outlet 5, the rim 6 of which is arranged to be disposed in a horizontal plane. Means (not shown) are provided to vary the height of the telescopically mounted rim 6 in relation to the fixed exit pipe 3 and the chamber 2. Such means may comprise the screw mounting of the pipe 4 onto the exit pipe 3. Alternatively, use may be made of suitably mounted screw operated components, rack and pinion means or other means acting as between the pipe 4 or its expanded end 5 on the one hand and, on the other hand, the pipe 3 or the chamber walls or base. Many other suitable means will be apparent to persons skilled in the art. Appropriate sealing means for example “O” rings (not shown) are employed to provide a seal between pipes 4 and 3.

When the rim 6 is lowered to a level below the surface of the water 7 in the chamber 2, water flows over the rim into the dished opening 5 and out through pipe 4 and exit pipe 3. Such water is replaced by water flowing from the body of water upstream through inlet 1. Such liquid flow will continue until the surface level of the body of water upstream falls to the level of the rim 6.

When the rim 6 is raised to a level above that of a body of water upstream, the flow of water through inlet 1 will cease. It will resume if the surface level of such body of water rises above the raised level of the rim 6, or if that level is appropriately lowered.

The level of the rim 6 may be very accurately controlled. The weir valve of the first aspect of the invention thus provides reliable and easily operable means for accurate control of the level of the surface of a body of water upstream and the rate of outward flow of water from such body.

Referring now to FIG. 1B of the drawings, the inlet connected to a body of water upstream is formed by pipe 3, and pipe 1 becomes the outlet pipe. The level of the rim 6 governs the surface level of the body of water upstream. Save for the fact that the direction of flow through the device is reversed, it will be seen that the arrangement of the device of FIG. 1B will be operated in the same way, mutatis mutandis, as that of the device of FIG. 1A.

Referring to FIG. 2, two weir valve units of the kind described with reference to FIGS. 1A and 1B are arranged in parallel. Water from an upstream body of water enters the first valve chamber 12 through inlet 11 and, under normal conditions, replaces the water that flows out of chamber 12 over the rim 16 of the expanded dish like inlet 15 of the telescopically mounted pipe 14 and out through exit pipe 13.

The first valve chamber 12 is connected by way of pipe 21 to the lower part of the second valve chamber 22 which comprises an exit pipe 23 on which is telescopically mounted the upwardly extending pipe 24 that tenninates at its upper end with an expanded dish like inlet 25 that is provided with a horizontally disposed rim 26. Save as to matters of physical dimensions, the essential features of the second weir valve arrangement represented in FIG. 2 replicate those of the first.

The first weir valve arrangement represented in FIG. 2 is designed to cope with normal conditions of operation affecting the upstream body of water. However, in the course of such operations, e.g. in an industrial or engineering context, the upstream body of water may discharge a sudden and unexpected large outflow of water that, when transmitted through inlet 11 into the first weir valve chamber 12 exceeds the capacity of its weir valve. In such a case, the excess flow of water enters the second weir valve arrangement through inlet 21. Rim 26 is set at a marginally higher level than rim 16. The level of the water 27 in the second weir valve chamber 22 rises above that of the rim 26 and water pours over the rim into the dished opening 25 and eventually out through the outlet pipe 23. The water remains at a level determined by the level of the rim 26 until the rate of flow through inlet 11 subsides to a rate that is within the capacity of the first weir valve arrangement. In this way, there will be no more than a minimal raising of the surface level of the body of water upstream, and hence flooding is avoided. If desired, one or more further weir valve arrangements may be installed downstream, mutatis mutandis, to cope with unusually high surges of water from the upstream body of water.

Referring to FIG. 3 in a weir valve according to a second exemplary embodiment of the first aspect of the invention, a fixed pipe 33 is in telescopic relationship with a support pipe 34 which has an expanded dish shaped upper end, the rim of the dish being provided with upwardly extending triangular projections 36a and 36b. Projections 36a extend to a higher level than projections 36b. For convenience, the projections which follow the circular rim of the dish shaped member 35 are represented schematically as extending in a straight line. Between the projections lie a plurality of trapeziums such as 18 or 19. Given the dimensions of the dish shaped member 35 and of the several triangles, the areas, both individual and aggregate of the several trapeziums may be readily calculated by reference to their height h above the lower end of the projections, as may the rate of change in such areas with change in h.

Weir valves according to the first aspect of the invention provide advantages in terms of ease of control of a complex fluid system which calls for precise simultaneous regulation of an interacting plurality of liquid flows and/or surface levels. Although the arrangement has been described in this specification as being suitable for use within apparatus for the separation of two or more liquids of different specific gravities, e.g. oil and water or oil, water and water/oil emulsion, it will be appreciated that such a system maybe used in many different applications within, for example, industrial manufacturing or refining plants.

Referring to FIG. 4, reference numeral 101 represents a corrugated plate with downwardly facing grooves 102, 103 and 104 and complementary upwardly facing grooves 105 and 16. The outer plate edges, ridges and groove base lines when seen in plan view are arranged to be parallel to each other. The angle between the groove walls decreases in the direction shown as “A”. At the same time, the height of the groove walls (base line to ridge) increases in the direction shown by “A”, as does their area per unit of distance in the direction “A”.

At one end of the corrugated plate, the grooves are shallow with a large angle between the side walls. At the other end, the grooves are deep and the angle between the side walls has been reduced.

At the “shallow groove” end of the corrugated plate, points 109 and 110 on the downwardly facing walls of groove 102 are each located at a distance “d” from line 111 which represents the location of the base line 111 of groove 102.

Adjacent the other end, points 111, 109′ and 110′ are also located on the downwardly facing walls of groove 102 at a distance “d” from line 111. It will be seen that the transverse distance between points 109 and 110 progressively decreases in the direction “A” towards locations 109′ and 110′ and the space between the groove walls is progressively constricted.

FIG. 5 represents a cross-sectional view of the “shallow groove/large angle” end of a Stacked Plate unit comprising plates according to an exemplary embodiment of the second aspect of the present invention; and

FIG. 6 represents a cross-sectional view of the “deep groove/small angle” end of the Stack Plate unit of FIG. 5.

Referring to FIG. 7, a mixture of oil and water to be separated flows through a pipe 1 21 into a separation chamber 120 which houses a Serial Tilted Plate arrangement of grooved plates of the invention. The pipe outlet 122 directs the mixture against the lower part of the downwardly facing side of the first tilted plate 123 as seen in side view. Tilted plate 123 and its grooves extend from the separation chamber base 127 upwardly to a level below the water surface. The depth of the grooves increases in the upward direction. The oil/water mixture is redirected so that it proceeds upwardly in contact with the downwardly facing grooves of plate 123. Oil from the mixture separates out and rises from the upper edge of the plate to the surface of the water where it floats as a layer 124 within the first surface accumulation zone 125.

Zone 125 is bounded by a barrier plate 126 which extends downwardly from above the fluid surface. At its lower end, it stops short of the base 127 of the separator chamber so as to provide a gap 128. In a useful embodiment of the present invention, base 127 overlies a layer of resilient impermeable material on which the respective bottom edges of the several tilted grooved plates of the invention rest. The weight of the plates bearing on the resilient material, supplemented if necessary by additional weights provides an effective seal. Alternatively, the bottom edges of the plates may be fitted into sealing slots.

Water and the remainder of the oil that has not been left behind in layer 124 continues its flow downwardly to the vicinity of base 127 of the separator chamber and through the gap 128 beneath the bottom of the barrier 126. The direction of the flow is reversed, and the fluids move upwardly in contact with the grooves on the underside of the next tilted grooved plate of the invention 129. Additional oil breaks off from the upper edge or edges of plate 129 and rises to the surface of the second surface accumulation zone 130 to form a floating layer of oil 131.

The process is repeated each time the fluid flow encounters a like combination of barrier and tilted grooved plate of the invention. At each successive surface accumulation zone, the amount of oil left behind diminishes. The number of successive combinations of barrier and grooved plate, and hence of surface accumulation zones, will depend upon the degree of separation sought and the cost advantages or disadvantages of adding further barrier/grooved plate combinations. The limit is reached when any of the oil that is still carried by the flow of water is in such a finely divided state as to call for other measures for further extraction. The thickness of the layer of oil in the final oil separation zones, even after prolonged operation may be no more than minimal. Such oil as may be present may in practice be swabbed off the water surface using oleophilic rags, swabs or sponges. Oil depleted water flows out of the separator chamber through outlet 132.

FIG. 8 represents schematically in part a Stacked Plate unit that has replaced one of the corrugated plates of the second aspect of the invention in the arrangement shown in FIG. 7.

Referring to FIG. 8, the shallow grooved ends of a plurality of tilted grooved plates according to an exemplary embodiment of the second aspect of the invention 141 to 145 inclusive making up a Stacked Plate unit are disposed in longitudinally staggered relationship to each other with the shallow grooved end of the outermost plate 141 extending beyond the corresponding end of its next adjacent grooved plate 142 which in turn extends beyond that of the third, 143, and so on. The bottom edge of plate 141 abuts against the resilient base layer 147 of the separation chamber to provide a seal at 146 in the manner already described, mutatis mutandis, in relation to the unitary grooved plates. Alternatively, the bottom edge may be fitted into a slot that provides an effective seal. Each of the several grooved plates within the Stacked Plate unit extends upwardly and terminates below the surface of a surface accumulation zone. A barrier plate 150 guides the flow of oil contaminated water down to the gap 151 between the bottom of the barrier plate and the base 147 of the separation chamber. The sealed support at 146 ensures that the flow is deflected upwardly so that it progresses in contact with the grooved undersides of the several plates 141 to 145 inclusive. After losing a portion of the oil at the surface accumulation zone located above the plates (not shown), the flow is guided downwardly by barrier plate 155 to the gap 156 between the bottom of barrier plate 155 and the base 147. It then encounters the lower end of another like tilted Stacked Plate arrangement or, alternatively, the lower end of a single tilted grooved plate of the kind described by reference to FIG. 7.

Referring to FIGS. 9 and 10 reference numeral 160 represents a separation chamber which comprises a Serial Plate arrangement of tilted corrugated plates of the second aspect of the invention together with their associated barrier plates arranged as described, mutatis mutandis in FIG. 7. Stabilised oil contaminated water from the stabilisation chamber 158 enters the separation chamber through inlet pipe 161. Oil separates out and floats to the surface within the respective surface accumulation zones. Oil depleted water comprising a small percentage only of the oil in the original oil contaminated water flows out of the separation chamber through outlet pipe 165 and into the upper end of an oil separation matrix filter chamber 166. The flow proceeds downwardly through the matrix or matrices 167, 167′ and onwardly through pipe 168 to the Tulip Valve chamber 169. The Tulip Valve exit pipe 170 supports a telescopically mounted pipe member 171 having an expanded open end 172 provided with a horizontal rim 173. Sealing means (e.g “O” rings) are provided between the pipe 170 and the pipe member 171. Means (not shown) are provided to regulate the height of the telescopically mounted pipe member 171 and, with it, the level of its expanded end 172 and the rim 173. Precise regulation of the upward and downward movement of the rim may be secured by providing an appropriate screw threaded telescopic mounting of the pipe 171 on the exit pipe 170. Alternatively, such regulation may be effected by rack and pinion means, or screw mounted means or other means well known per se for adjusting the length of intermediate support members.

During operation, oil depleted water from the filter matrix chamber 166 passes through the outlet pipe 168 into the Tulip Valve chamber 169. Its surface level within chamber 166 is governed by the level of the Tulip Valve weir rim 173. This can be varied and set with precision. The fluid connection through pipe 165 to the separation chamber 160 enables the fluid surface level within the separation chamber 160 also to be covered by the level of the Tulip Valve rim 173.

Within the separation chamber 160, layers of floating oil 181, 182 and 183 are represented as having accumulated on the surface of the water in the first 3 surface accumulation zones. Located in such zones are the inlets 175, 176 and 177 of oil removal pipes (not shown). The inlets are represented schematically and for the purpose of explanation in FIGS. 9 and 10 as being set in the side wall facing sideways. In general and in actual practice, it is preferred that the inlets be located within the respective surface accumulation zones facing upwardly and screw mounted for precise adjustment of the respective vertical levels of the inlet rims. Such levels are determined by reference to the working level of water within separation chamber 160. Water unaccompanied by oil is passed through the separation chamber. Its level is adjusted so as to arrive at the desired working level by adjustment of the level of the weir rim 173 of the downstream Tulip Valve. When the desired working level of the water has been secured, the inlet rims are set at a level that is at the appropriate short distance above the working level of the water that results in the admission of oil into any inlets when floating oil in its proximity has attained a sufficient thickness.

The setting sequence may be reversed. The level of the inlet rims may be set firstly and the working level of the water secondly by adjustment of the height of the weir rim 173. By reason of the maintained difference in level between the water surface and the inlet rims, water cannot flow out of the separation chamber 160 through any of the inlets in the course of operation.

(In the case where there is no downstream surface regulating means such as a Tulip Valve and the working level of the water is dictated by, for example, the level of the separation chamber's fluid outlet, the necessary adjustments are made to the levels of the inlet rims alone).

As surface oil accumulates in any surface accumulation zone in a continuously thickening layer, the fluid surface level (i.e. that of the floating oil) will rise. Each inlet within a zone (exemplified herein by inlets 175, 176 and 177) is set with its rim at a level so that when the thickness of the oil layer in its particular zone exceeds a certain value, oil will flow over the rim into the inlet and then away through that inlet's associated oil removal pipe.

In FIG. 9, the floating oil layer 181 in the first surface accumulation zone within the separation chamber 160 is represented as being thick enough to raise the oil surface level above the rim of inlet 175. Oil spills over into the inlet 175 and is carried away by its associated oil removal pipe (not shown).

Within the second surface accumulation zone, the floating oil layer 182 is represented as being thick enough to raise the oil surface up to the rim of the inlet 176. With the accumulation of additional oil, layer 172 will increase in thickness. As its surface level rises, oil will spill over into the inlet 176.

Within the third surface accumulation zone, the surface level of the floating oil layer 183 is represented as not having risen to the level of the rim of inlet 177. In due course, such surface level can be expected to rise until oil eventually spills over into the inlet.

Successively smaller amounts of oil accumulate in the successive downstream surface accumulation zones. Eventually, a stage is reached where it becomes more convenient to remove such surface oil as accumulates in downstream surface accumulation zones using other means, e.g. oleophilic rags, swabs, sponges or the like.

The rate of fluid flow through the separation system and the fluid surface levels within the system may be adjusted rapidly and with precision by raising or lowering the Tulip Valve weir rim 173. If desired, a second Tulip Valve arrangement may be located downstream of the subsisting Tulip Valve so as to accommodate any unexpected and undesired surges in the liquid flow rate through the system. The weir rim of the second Tulip Valve is set at a level that is marginally higher than that of the first. In this way, the effect of a sudden increase or surge in fluid flow is limited to no more than a marginal raising of the fluid surface level within the system.

The stabilisation chamber 158 as represented in FIGS. 9 and 10 is interposed as may be necessary or desirable between the oil/water feed delivery system and the separation chamber 160. When called upon to operate, a turbulent, pulsating stream prone to internal vibrations is admitted through the inlet 159 to face an encounter with a Clock Spring Guide housed within the chamber. The Guide guides the stream into the helical path that leads towards its central zone between the coils of its wall member 178. The height of the wall member's rim may be evenly maintained along its length, or else, advantageously, it may increase. As the troubled feed stream travels along the helical path, its disruptive elements are palliated. It emerges, much pacified, through the base outlet aperture 179 that leads to a lower chamber 180. There, it is further placated by an encounter with one or more horizontal baffle plates 181 disposed across its path before it continues, now flowing serenely through pipe 161 into the separation chamber 160.

Referring to FIG. 11 of the drawings, reference number 201 represents a helical wall member extending from its outer end at 202 to its inner end at 203 and defining between locations 202 and 203 a helical path 204. A circular outlet aperture in the base member is represented at 205 and 206 represents the inlet of an oil removal pipe that extends upwardly through the aperture 205. The height of the level of the upper rim of the wall member 201 is progressively lowered along the direction towards the centre 207 of the helix as indicated in FIGS. 12 and 13.

The outer edge of the base member (not shown in FIG. 11) on which wall member 201 stands may follow the line of the outer part of the helical wall member 201. In this case, the Clock Spring Guide is adapted to act independently to separate oil from water without an enclosing vortex chamber. (“Independent Clock Spring Guide”). Where the Clock Spring Guide is adapted to operate within a vortex chamber, the edges of the base member extend to the inner wall surface of the vortex chamber.

In FIG. 12, a layer of floating oil borne on the surface layer of a flowing stream of water is admitted into a vortex chamber 211 through the vortex chamber inlet 212. Inside, the helical wall member 201 stands on a dished base member 215. On entering the chamber, the lower layer of the water is guided by the helical wall 1 along the helical path 204. The drag effect of the water constrained to follow the helical path results in the formation of a vortex in which all the water rotates together with the layer of oil that floats on top. As more water enters through inlet 212, water escapes from the water vortex downwardly through outlet aperture 205 in the base member. The floating layer of oil thickens to form a three dimensional floating vortex 213 that hangs suspended above the helical wall. Its oil/water interface assumes the configuration of an inverted bell curve. The continuous flow of water entering through the inlet 212 and exiting through the outlet aperture 205 ensures a continuous support for the oil vortex together with a continuous rotational drag upon it at the oil/water interface.

The inlet 217 of the oil removal pipe 206 is located within what may be termed a stable “reservoir” of oil provided by the oil vortex. In the case where the device operates on a stable base, advantage may be taken of the Density Differential principle referred to above. The rim of inlet 217 may be located within the vortex chamber at a height that stands proud of the fluid surface level when water alone flows through the vortex chamber. When a floating oil vortex is formed on the water surface, the fluid surface level rises and, in due course, oil flows over the rim of inlet 217 into the oil removal pipe 206. Horizontal baffle plate 215 encircles oil removal pipe 206 at a location below the floating oil vortex 213. In this way, the Clock Spring Guide provides a self-regulating system from which separated oil flows out of its own accord for collection.

In FIG. 13, the wall member 221 of the device has a helical configuration of the kind indicated in FIG. 10 when seen in plan view. In this case, the device is adapted to act as an Independent Clock Spring Guide. A barrier plate (located as indicated schematically in plan view by the broken line 230 in FIG. 10) extends upwardly from the base 228 and bridges the gap between the outer and the first inner coils of the helical wall member at or adjacent to the mouth of the helix. It terminates a short distance below the fluid surface level 231 of the flow from outside. This ensures that entry into the device is limited to floating oil and an adjacent supporting layer of surface water only. The level of the upper rim of helical wall member 221 is progressively lowered in the direction of the centre of the helix with an initial steep downward inclination immediately downstream of the barrier plate to a level below the oil/water interface when an oil vortex 223 is formed. During operation, oil and water pass over the barrier plate. The lower layer of the admitted water moves along the helical path 224 and its drag effect converts the fluid contents of the device into a vortex. The oil accumulates and forms the floating oil vortex 223. Oil is withdrawn through the inlet 227 of oil removal pipe 226 located within the vortex, and the water flows out through the outlet aperture 225 in the base plate member 228.

Water from the outlet aperture 225 passes through outlet pipe 229 which is provided with one or more inwardly directed spiral projections represented in broken lines at 232 extending downwardly from the aperture 225 to the pipe outlet 231 and serving to impel downwardly and outwardly the rotating mass of water flowing from the outlet aperture.

A horizontal baffle plate 234 encircles the oil removal pipe at a level below the oil/water interface at the bottom of the oil vortex 223.

In FIG. 14, an oil and water mixture enters stabilisation chamber 240 and encounters Clock Spring Guide 242 where the mixture is subjected to the stabilising influence of the passage along the helical path between the helical wall members. The mixture emerges through the base outlet aperture 243 and flows past one or more horizontally disposed baffle plates represented at 244 in the space below the base outlet.

The stabilised mixture moves on through pipe 245 into the vortex chamber 250 where it encounters a Clock Spring Guide device 251 and separates out to form an oil vortex 253 that floats above the aqueous vortex begotten by the Clock Spring Guide's helical wall member. The water flows out through the outlet means 255 that passes through the base member of the Clock Spring Guide and is led away from pipe 258.

Prior to the entry of the oil and water mixture into the chamber 250, a flow of water alone is passed through the chamber. The fluid surface level when water alone is present in the chamber is indicated by the transverse line 259. The rim of the inlet 257 of an oil removal pipe is set at a level that is close to but above the level indicated by the transverse line 259. When later the oil accumulates in the floating oil vortex 253, the fluid surface level is elevated. As the oil continues to accumulate, its surface level rises above the rim of the inlet 257. Oil flows over the rim and into the oil removal pipe.

In FIG. 15, a floating boom 260 is represented as extending diagonally across the surface of a body of water flowing in the direction indicated by “A” which bears on its surface a continuous or intermittent layer of floating oil. At the upstream side of the boom, the floating oil is diverted so that it runs along the side of the boom in the direction indicated by “B”. Two Independent Clock Spring devices 261 and 262 having the configuration represented in FIG. 13 above rest against the upstream side of the boom 260 with their inlets facing the diverted flow. They are buoyantly supported by the floatation means 267 and 268, the seat members 265 and 266 and the boom 260 itself.

Barrier plates represented by broken lines 230′, 230′ restrict liquid entry to the floating oil and a supporting layer of surface water. The oil accumulates within each

Independent Clock Spring Guide in the form of a floating oil vortex such as that represented at 223 in FIG. 13. Oil is withdrawn through an oil removal pipe 227′ extending downwardly from the interior of the oil vortex. The oil may be transmitted along the boom to an on shore collection point, or it may be stored in storage bags located within the body of water.

Water escapes from the underlying water vortices through the annular apertures in the respective base members of the devices 225′, 225′ that surround the oil removal pipes 227′, 227′ and passes through downwardly extending outlet pipes (not shown) the walls of which are provided with spiral inward projections which propel the rotating water downwardly and out of the device (c.p. FIG. 13). This promotes the admission of replacement surface oil bearing water over the barrier plates 230′, 230′ disposed across the mounts of the respective helixes.

In FIG. 16, two vortex chambers 270, 271, each housing a Clock Spring Guide are linked by pipe 273. An oil/water feed stream is passed through the vortex chamber 270 resulting in the formation of a floating vortex of oil within the chamber. Pipe 273 carries the flow of water and residual oil that has emerged through the base member outlet 274 of the Clock Spring Guide housed in vortex chamber 270 to the second vortex chamber 271. There the flow encounters the second Clock Spring Guide. Residual oil present in the water separates out to form a second floating vortex 275 which, over a period of time, increases in thickness so that the fluid surface level rises until oil spills over the inlet 276 into the oil removal pipe 277. For further oil extraction, water together with any residual oil that has survived passage through the vortex chamber 271 may flow onwards through pipe 278 to a further like vortex chamber that houses a Clock Spring Guide; and the sequence may be repeated.

Following the passage of the water through the last vortex chamber in line, a final oil separation step may be provided by passing the water through a filter matrix of a known kind comprising e.g. matted polyurethane fibres or polyurethane foam.

Insofar as the above description has been limited in terms to means and methods for the separation of oil and water, it will be appreciated that such description will apply, mutatis mutandis to the separation of any two comparable immiscible liquids having different specific gravities; and the description of embodiment of the fourth aspect of the invention is intended so to apply.

In FIGS. 17 and 18 reference numeral 301 denotes a vortex chamber which receives the feed mixture of oil and water to be separated through the inlet 301. A Clock Spring Guide having a wall member 303, that stands on a base 317 and which provides a helical path is located within the vortex chamber. An oil removal pipe 305 has its inlet 304 at a level above the wall member 303 and extends downwardly through the outlet aperture 316 in the base member 317 of the Clock Spring Guide. Around the upper part of pipe 305 and below the location of the bottom of the oil vortex id disposed a baffle plate 330, the function of which is to restrain the occasional tendency of the floating oil vortex to be distended downwardly with consequent breaking off of the lower parts of the vortex.

As shown in FIG. 17 for the first near complete circuit, the helical path provided by wall member 303 proceeds between the vortex chamber inner wall and the outer wall of the helical wall member 303 of a Clock Spring Guide. Thereafter, the path proceeds between the opposing sides of the wall member to the zone surrounding the centre of the helix where there is located a liquid outlet aperture 316 in the base member 317. When the feed mixture enters the vortex chamber 301, it encounters the whirling mass of fluid whose rotation is generated and maintained by the combined effect of the tangential entry and the drag effect of the lower part of the water mass that flows along the helical path. Oil migrates upwardly and inwardly through the surrounding water by reason of its lower specific gravity. A centrally disposed floating oil vortex 313 is formed. As the continuous stream of feed mixture brings additional oil into the vortex chamber, more oil joins the vortex 313. The oil vortex assumes the shape of an inverted bell-curve that spins around its axis. It floats above the helical wall member 303 of the Clock Spring Guide, supported by the rotating stream of water as the water progresses through the chamber to the outlet 316 in the base member 317. As it proceeds towards the outlet 316, the lower part of the swirling mass of water enters the spiral path of diminishing radius provided by the Clock Spring Guide. This adds impetus to its rotational motion. As a result, the water exerts a drag effect from below upon the overlying fluid layers. This, in addition to the effect of tangential entry sets up and maintains the rotational movement of all fluid within the vortex chamber.

The level of the upper rim of the helical wall member 303 is progressively lowered in the direction of the zone surrounding the centre of the helix. This is done so as to accommodate the pendulous submerged portion of the oil vortex 313. The best results are obtained when the interface 306 between the oil vortex and the supporting water does not extend downwardly as far as the upper rim of the wall member 303.

The inlet 304 of a downwardly directed oil extraction pipe 305, is arranged to be located within the oil vortex. Preferably, the height of the rim of inlet 304 is made adjustable, e.g. by screw mounting the inlet 304 on to the oil extraction pipe 305. When the surface level of the floating oil vortex rises above the level of the rim of inlet 304, oil flows of the vortex chamber through pipe 305.

Water flows out of the vortex chamber 301 through outlet 316 in the base member 317 of the Clock Spring Guide component. Outlet 316 may be supplemented by small peripheral outlets (not shown) located, preferably symmetrically in the base member 317. Their function is to discourage a distortion of the shape of the submerged oil vortex leading to a breakaway of oil from the vortex to join the outflow of water. Where use in made such small supplementary outlets, most of the water flow nonetheless leaves the vortex chamber through the outlet 316.

The water may then, optionally, be passed through a stabilizing zone comprising one or more horizontal baffle plates disposed across the direction of its flow.

The water flows onwardly through pipe 307 into the weir valve arrangement constituted by the Tulip Valve chamber 308. Water fills the chamber 308 up to the level of the Tulip Valve chamber 308. Water fills the chamber 308 up to the level of the Tulip Valve weir rim 309. As more water enters chamber 308, a stream of water spills over the rim 309 and into the Tulip Valve outlet pipe 310.

Weir rim 309 forms the rim of the expanded opening 311 of the downwardly extending pipe 312 which is mounted telescopically onto the outlet pipe 310. Upward and downward movement of the rim may be precisely controlled by providing a screw mounting as between the pipe 312 and the outlet pipe 310. Alternatively, use may be made of other means whereby longitudinal adjustment may be made to the relative positions of one pipe or tube telescopically mounted on another.

The level of the downstream weir rim 309 governs both the fluid level in the vortex chamber and the rate at which water flows through the vortex chamber.

The “Density Differential” principle for the removal of separated oil from the oil vortex is put into operation. (See discussion in the text above). The weir rim 309 and of the rim of inlet 304 are respectively set at levels, the one in relation to the other which will ensure that when water alone flows through the chamber, the inlet rim stands proud of the water surface, but when the thickness of a floating layer of separated oil within the vortex chamber exceeds a particular value, oil will flow through the inlet 304 and out through the oil removal pipe 305. See also the matter set out in the text above under the heading “Removal in practice”.

Upstream Stabilisation

Where necessary or desirable, an upstream stabilisation chamber 320 may be employed to dampen or eliminate-disruptive turbulence, pulsations and/or vibrations transmitted from an upstream pump or the like which may be prejudicial to the stability and the smooth running of the separation process within the vortex chamber 301. In the embodiment of the invention described by reference to FIG. 17 and FIG. 18, the oil/water feed mixture on entering the stabilisation chamber 320 encounters a Clock Spring Guide arrangement whereby the feed stream is conducted along a helical path defined by the inner wall of the chamber 320 and the helical wall member 321 of the Guide before flowing downwardly through the base outlet aperture 322 into a lower chamber comprising one or more horizontal baffle plates 323 disposed across the direction of the flow. For this application, the upper rim of the wall member 321 maintains a constant height or else increases in height in the direction of the flow towards the central zone.

The use of the stabilisation chamber 320 provides self evident advantages in stabilising the flow of oil/water mixture into the vortex chamber and in damping down turbulence, pulsations and/or vibrations in the feed mixture. As an alternative to a vortex chamber, upstream stabilisation may be effected as mentioned above by the gentle flow of the oil/water feed mixture along channels or conduits under and between horizontal or slightly tilted corrugated baffle plates with their corrugations disposed in the direction of the flow. Preferably, use is made of “Lemer Plates” as defined above disposed with their groove depth increasing in the direction of the flow.

In FIG. 19 and FIG. 20, a tilted corrugated plate separation chamber 340 and a filter matrix chamber 360 are interposed between the vortex chamber 301 and the Tulip Valve chamber 308 of FIG. 17 and FIG. 18 above. Elements or features represented in the drawings of FIG. 17 and FIG. 18 are numbered as in FIGS. 17 and 18 but with a suffix “a” in each case so that the vortex chamber 301 and weir chamber 308 of FIGS. 17 and 18 become the vortex chamber 301a and the weir valve chamber 308a in FIGS. 19 and 20, and so on.

In a preferred embodiment of the third aspect of the present invention, the construction and operation of the separation chamber 340 and of its associated tilted corrugated plates are as described in relation to the second aspect of the invention. In the description relating to the second aspect of the invention, the corrugated plates described and used are limited to “Lemer Plates”. In other embodiments of the third aspect of the present invention, the tilted corrugated plates may include those commonly used in known tilted corrugated plate oil separators.

Referring to FIG. 19 and FIG. 20, water from the vortex chamber 301 a carrying with it a residual amount of oil enters the separator chamber 340 through inlet pipe 341 and impinges against the lower part of a downward facing side of a tilted grooved plate 342 extending from the base of the separation chamber upwardly to a level below the liquid surface. Its corrugations lie in the direction of the fluid flow. As the partially decontaminated water flows upwardly in contact with the downwardly facing corrugated side of plate 42, oil particles coagulate into droplets which, on reaching the upper edge of the grooved plate, break off and float to the surface. As the flow continues, the droplets accumulate to form a layer of floating oil 343. This layer is located within a zone 344 (the first surface accumulation zone) bounded by barrier 345 that extends downwardly from above the fluid surface, stopping short of the base of the separator chamber so as to provide a gap 346. Water together with the oil that has not been left hind in layer 343 is guided downwardly by the barrier 345 and passes through gap 346 to impinge against the lower part of the second tilted grooved plate 347. It then moves upwardly in contact with the grooves along the underside of the plate. Additional oil breaks off from the upper edge of tilted grooved plate 347 and rises to form a second floating oil layer 348 within the second surface accumulation zone 349. This process is repeated, mutatis mutandis, each time the fluid flow encounters a like combination of barrier plate and tilted grooved plate.

In FIG. 21, 351 represents isometrically a “Lemer Plate” that has downwardly facing grooves 352, 353 and 354 and complimentary upwardly facing grooves 355 and 356. The outer plate edges 358 and 359, ridges 361,362 and 363 and groove base lines when seen in plan view are arranged to be parallel to each other. The angle between the grooved walls decreases in the direction shown as “A”. At the same time, the height of the grooved walls (base line to ridge) increases in the direction shown by “A”. When using Lemer Plates in a tilted plate oil separator, each plate is disposed so that the depth of the grooves progressively increases whilst the mean angle (as defined above) simultaneously decreases in the direction of the fluid flow. In the present instance, the partly decontaminated water will flow upwardly in contact with the undersides of the plates. Oil particles carried by the flow will rise towards the apices of the inverted grooves. There, they are constrained to move along a path that becomes progressively more constricted. This promotes coagulation leading to the formation of the droplets that eventually break free from the upper edges of the plates and float to the surface.

(Although the Lemer Plate described by reference to FIG. 21 above is referred to and depicted as having parallel sides and ridges, the definition of a Lemer Plate at its broadest will include the case where the sides and ridges are not necessarily parallel).

The corrugated plate separator separates out all but a small proportion of the residual oil carried over by the flow of water from the vortex chamber. At each successive surface accumulation zone, the amount of oil left behind diminishes. The number of successive combinations of barrier and grooved plate, and hence of the surface accumulation zones will depend upon the degree of separation sought and the cost advantages or disadvantages of adding further barrier/grooved plate combinations. The limit may be reached when any of the oil that is still carried by the flow of water is in such a finely divided state as to call for other measures for further extraction. The thickness of the layer of the oil in the final oil separation zones, even after prolonged operation, may be no more than minimal. It may be possible in practice to remove such oil as may be present using oleophilic rags, swabs or sponges.

The respective surface fluid levels within the vortex chamber 301 a and within the several surface accumulation zones in the separation chamber 304 are all regulated and set by the level of the weir rim 309a of the Tulip Valve arrangement downstream.

Removal of Oil from the Separation Chamber

Within or leading out of the surface accumulation zones are oil removal pipe inlets. Each inlet leads to an oil removal pipe through which oil will flow away from the apparatus of the invention. In FIGS. 19 and 20, the inlets are represented schematically and for the purpose of explanation by sideways facing pipe elements 365,366 and 367. In actual practice, however, it is preferred that the inlets be located within the respective surface accumulation zones facing upwardly and having vertically adjustable rim levels, e.g. as provided by screw threaded telescopic mounting on to their respective oil removal pipes.

The respective levels of the oil removal inlet rims are set at a level that will enable the Density Differential principle referred to above to be applied to the removal of oil from the vortex chamber. That is, the height or heights of the rims of the respective inlets on the one hand and the height of the weir rim 309a on the downstream Tulip Valve on the other hand are arranged to be such that

(a) where water alone flows through the system, the outlets stand proud of the water level, but

(b) where a layer of oil accumulates within the surface accumulation zones or any of them, the fluid surface will rise. When the layer has become sufficiently thick, oil in each case will flow over the oil removal inlet rim provided for the zone in question and away through its associated oil removal pipe.

See also the discussion under the heading “Removal in practice” above.

As already indicated by reference to the embodiment of FIGS. 17 and 18, the fluid surface level within the vortex chamber is also regulated by the level of the weir rim of the downstream Tulip Valve. Thus the mechanism whereby the oil is removed from the separation chamber is the same, mutatis mutandis as the mechanism described above whereby oil is removed from the vortex chamber 301a. A twofold result, being the separation of oil using vortex means within a vortex chamber and, in addition, the separation of the removable residual oil flowing out of the vortex chamber is achieved by use of Means A in conjunction with the application of the Density Differential principle.

FIGS. 19 and 20 in addition disclose the interposition of a filter matrix chamber 360 between the separation chamber 340 and the weir valve arrangement in chamber 308a. By the time the flow reaches the filter chamber 360, no more than a minimal amount of oil may be carried by the water. The flow proceeds downwardly through the chamber 360. One or a series of filter elements 365 are disposed across the path of the flow to trap the very finely divided particles of oil that resisted capture within the separation chamber.

The water is thus provided with its final “polish”. Since a very high proportion of the oil will already have been removed before the water enters the filter chamber 360, the cost and effort of replacing or refurbishing the filter elements is minimised.

In the embodiment of the invention represented by reference to FIGS. 22 and 23, a stream of water 371 bearing a floating layer of oil 372 enters a vortex chamber 373. Gate 374 hinged at 375 opens to admit the layer of oil and a supporting upper layer of the water through the vortex chamber inlet. Horizontal plate 376 is connected to the lower edge of the gate 374 and moves partly into the interior of the vortex chamber when the gate is opened. The lower layer of the water enters through the lower part 377 of the vortex chamber inlet and continues along a horizontal helical path of diminishing radius provided by the inner wall of the chamber acting in conjunction with the helical wall member 378 of a Clock Spring Guide located within the chamber. A swirling fluid mass is thus formed in the chamber which includes a stable turbulence free vortex of floating oil 386 at its centre. The rate at which oil enters the vortex chamber to join the oil vortex may be controlled by the gate 374. (Gate 374 thus constitutes “Means D”: see above). On shutting the gate 374, the oil accumulates in a thickening layer outside the vortex chamber. When the gate is opened, horizontal plate 376 serves as a baffle which helps to shield the floating oil on entry into the chamber from the disruptive effect of the rapidly rotating mass of water below.

The helical wall member 378 of the Clock Spring Guide stands on the base member 379 that is provided with an outlet aperture 387 which constitutes the vortex chamber outlet. Water flows downwardly through this outlet and through the conduit member 388 into a Tulip Valve arrangement contained in the chamber 380. The Tulip Valve weir rim 381 is set at a level that regulates the rate at which the water flows through the vortex chamber 373 and, in addition, the fluid surface level within the vortex chamber. Thus when no oil is present, the fluid surface level (of the water) as set by the weir rim 381 will be below the level of the rim of the inlet 382 to the oil removal pipe 383. But when a layer of oil of sufficient thickness floats on the water in the vortex chamber, the surface level of the floating oil will rise above the level of the rim of the inlet 382, and oil will flow into the oil removal pipe 383.

In this particular embodiment, the floating oil vortex 386 is connected to a separate Tulip Valve arrangement located in chamber 385. In this way, there is provided a further means for regulating the surface level of the floating oil in the vortex chamber together with means for regulating the rate at which oil is withdrawn from the floating vortex. (“Means C”). This is done by adjusting the level of the weir rim 389 of the Tulip Valve arrangement upwardly or downwardly as required. In the embodiment represented in FIG. 22, the oil removal pipe 383 carries the oil from the oil vortex 386 to the chamber 385. Pipe 390 having an expanded end portion 391 that terminates with the weir rim 389 is mounted telescopically on to the outlet pipe 392. Oil from the oil vortex flows over the weir rim 389 and out through outlet 392. Water that accompanies the flow of oil from the vortex 386 separates out in chamber 385 and accumulates as a layer 393 at the bottom of the chamber whence it is periodically removed through outlet 394.

The rate of the flow of water through the vortex chamber will respond to the surface fluid level in the chamber. Thus the Tulip Valve arrangement in the chamber 385 may be constitute means for regulating such rate.

The arrangement of FIGS. 22 and 23 has proved particularly useful in the separation of oil from water where the oil/water feed had first been stabilised by passing it through a “horizontal flow” stabilisation stage which comprised the use of slow moving flow zones, baffles and a trough in which were located submerged, longitudinally disposed Lemer Plates as described by reference to FIG. 21 tilted at a shallow angle. The original oil/water feed mixture came from a MANTIS (T.M) Skimmer working in an industrial environment on the surface of a body of water covered by a coating of heavy waste oil. Following such stabilisation, the oil separated from the water and floated as a discrete layer on the surface of the water flow that entered the vortex chamber.

A vortex chamber arrangement as described by reference to FIGS. 22 and 23 is also ideally adapted for Marine Applications under stable conditions, e.g. where the apparatus is land based or securely mounted on stable buoyant support to receive a river, tide dome or induced flow of surface oil contaminated water.

FIG. 24 represents a sectional side view of the apparatus of FIG. 22 to which has been added a by-pass conduit means that constitutes a “Means B” i.e. means adapted to regulate the flow of water through by-pass means arranged to divert water that enters the forward part of the apparatus upstream of the vortex chamber away from the chamber. Save for such addition, FIG. 24 replicates FIG. 22; and for convenience, elements or features appearing in FIG. 24 that also appear in FIG. 22 are given the same numbering, but with the suffix “a”.

In FIG. 24, a by-pass conduit 400 leads from the lower levels of the mass of water 371 a in the forward part of the apparatus upstream of the vortex chamber 373a to chamber 401 that houses a Tulip Valve. During operation, water flows through the conduit 400 into chamber 401 where it spills over the weir rim 402 of the Tulip Valve into the exit pipe 403. The level of the rim 402 of the Tulip Valve into the exit pipe 403. The level of the rim 402 of the Tulip Valve, if acting alone, will regulate the rate of flow of the water through the by-pass conduit 400 and, in addition, the fluid surface level above the water 371a which, in turn will influence the fluid surface level in the vortex chamber 373a.

FIG. 24 thus represents embodiments of each of the Means A to D. Means A and Means C are represented respectively by the Tulip Valve arrangement in chambers 381 a and 385a, and Means D by the gate 374a. Means B is represented by the Tulip Valve arrangement in chamber 401.

Where two or more flow control means are put to work in a fluid system as represented by FIGS. 22, 23 and 24, the operation of the one will inevitably have an effect upon the operation of one or more of the others. Taking for example the embodiment of FIG. 24, an increase in the flow through the by-pass conduit 400 regulated by Means B could lower the fluid surface level of the water 371a immediately upstream of the vortex chamber. This in turn, acting alone will reduce the rate of gravity induced flow into and through the vortex chamber unless compensated (in the circumstances, possibly temporarily) by a lowering of either or both of the relevant Tulip Valve weir rims in chambers 380a and/or 385a and/or the opening of gate 374a. Likewise, any variation of the flow regulated by any or, more of the other Means will affect the overall operation of the system. It is the task of the operator to adjust and set the relevant weir rim levels and the gate opening so as to secure optimum operation of the apparatus of the invention in any particular circumstances. In the course of practical operations, satisfactory settings for coping with the different circumstances that arise are arrived at by trial and error. By way of example, the periodic adjustments and settings of Means B could be crucial factors in Marine Applications where the relative forward speed of the apparatus in relation to the income flow of surface oil bearing water and/or the thickness of the oil layer can vary unpredictably. Such variations will also have an important bearing on the necessary settings of each of the other Means A, C and D. On the other hand, in a stable industrial environment not subject to unpredictable changes in operational circumstances, satisfactory performance may be secured by the adjustment and setting of Means A, C and D only.

The above considerations will apply, mutatis mutandis, in the case where one or more of the fluid flow regulating arrangements referred to by reference to the drawings is replaced by another suitable fluid flow regulating valve arrangement.

FIGS. 25 and 26 represent an arrangement in which an exemplary embodiment of apparatus according to the third aspect of the present invention is buoyantly supported in a partly submerged state between two parallel hulls or booms 410 and 411 for removing floating oil from a body of water. A pair of forwardly extending divergent booms 415 and 416 are arranged to divert oil bearing water into the forward part of the apparatus. The arrangement may be anchored facing upstream in a river or tidal flow. In static water, fluid flow through the apparatus is induced by rearwardly directed water propulsion means 412. In general, such means may be employed:

i. to augment or induce the flow of oil bearing surface water into the forward part of the apparatus between the forwardly extending divergent booms 415 and 416 and, additionally

ii. where required, as propulsion means for driving the buoyantly supported apparatus forwardly over a body of surface oil contaminated water.

The apparatus of FIGS. 25 and 26 comprises a vortex chamber 413 that is provided with an inlet 414 through which flows the oil bearing upper layer of a stream of water that has been diverted by the boom arms 415 and 416. Downstream of the boom arms, a fixed barrier plate 435 is mounted across the base 420 of the forward part of the apparatus. This plate allows entry into the apparatus of the oil bearing upper layer of water 436 only from the outer body of water. Slidable gate valve plates 417 and 418 are located adjacent the base 420 of the forward part of the apparatus upstream of the vortex chamber inlet 414 and well below the water surface level 421 when the apparatus is buoyantly mounted for operation. They are adapted to close and open the irrespective associated apertures 419 and 432 that lead respectively to by-pass conduits 433 and 434. They may be operated manually or else by means that respond to fluid surface levels in the forward part of the apparatus and/or within the vortex chamber.

The apparatus of FIGS. 25 and 26 is adapted to separate floating oil from water. Hence if desired, and dependent upon the circumstances, the particular features relating to regulation of flow through the vortex chamber inlet that characterise the embodiments of FIGS. 22, 23 and 24 above (including Means D) may, but need not be added to the FIGS. 25 and 26 embodiment.

Within the vortex chamber 413 of this embodiment, a combination of tangential entry and the influence of the helical wall member 422 of the Clock Spring Guide results in a rotating fluid mass within which the oil separates out to float as a vortex 423 on the surface of the water. Water escapes from the vortex chamber through the base outlet 424 of the Clock Spring Guide incorporated within and forming part of the vortex chamber. An oil removal pipe 425 has its inlet 437 adapted to be immersed in floating oil vortex 423 and extends downwardly through the outlet 424 and then through the lower chamber 427 located below the vortex chamber. On leaving the vortex chamber through outlet 424, the water flows into the lower chamber 427 and then rearwardly through the lower chamber outlet 428 into exit conduit 429 that leads to the rear outlet 430 of the apparatus. The rate of water flow through the vortex chamber is regulated by a gate valve which comprises a vertically slidable plate 426 adapted to control flow through the outlet 428. Gate valve plate 426 may be operated manually or else by means that respond to the fluid surface levels in the forward part of the apparatus and/or within the vortex chamber. Rearwardly directed water propelling means such as a screw propellor 412 of an outboard engine is mounted behind the rear outlet 430. Alternatively, the propellor may be mounted for static operation within the conduit 429 upstream of the outlet. By impelling rearwardly the flow of water that has passed through the apparatus, it sets up or augments the inward flow of replacement water. In non static operations, it drives the buoyantly supported apparatus forward.

The slidable gate valve plates 417 and 418 control entry of water into their respective associated apertures 419 and 432 leading to by-pass conduits 433 and 434 respectively. Both conduits are adapted to carry water from the forward part of the apparatus past the vortex chamber to the junction of each with the conduit 429 where such water is joined by the flow from the outlet 428 of decontaminated water that has passed through the vortex chamber 413. The combined flows make their exit through the exit conduit 129. During operation, the by-pass arrangement brings Means B into play. The fluid surface level in the forward part of the apparatus between the forward barrier plate 135 and the inlet 414 to vortex chamber is regulated by the sluice gate valve means operated by reference to slidable plates 417 and 418. In the face of a continuous oncoming feed stream, the level will be raised by restricting access to the by-pass means, and vice versa. The fluid surface level within the vortex chamber 413 will respond to the fluid surface level in the forward part outside the inlet 414. Raising such fluid surface levels results in an increase in the rate of flow through the vortex chamber, and vice versa. Simultaneously, Means A is available by way of the downstream sluice gate valve means operated by reference to slidable plate 426 that controls aperture 428. The separated oil is drawn from the oil vortex through the oil removal pipe 425 for temporary storage in floating storage bags or container tanks or the like.

The preferred embodiments of the third aspect of the present invention has no moving parts. It provides an economical and adaptable system for the separation of oil from water in several different contexts ranging from heavy industrial applications in a hostile environment to light commercial applications in, for example, local garages, parking areas, factory basements and other places that promise to be subject to increasingly demanding environmental controls.

For large scale operations, several units are connected to work on the contaminated flow in parallel, and advantage is taken of the larger working surface area and enhanced capacity provided by the “Stacked Plate” arrangement referred to above.

In Marine Applications, the third aspect of the invention provides light, transportable, economical and effective means for recovering floating oil. The mobile embodiment, i.e. the embodiment adapted to be propelled forwardly by an outboard engine or the like is ideally suited for operation under radio and/or electronically programmed control. A large area of surface contaminated water can be readily, expeditiously and efficiently treated. The running costs will amount to little more than those of providing and running a simple marine outboard engine.

Embodiments of the various aspects of the present invention have been described above by way of examples only, and it will be apparent to persons skilled in the art that modifications and variations can be made without departing from the scope of the invention as defined by the appended claims.

1. A weir valve arrangement which comprises a pipe member having an expanded upper end bounded at least in part by a rim, the rim optionally being provided with a projection, preferably contained and maintained in a substantially horizontal plane, the length of the rim or of its horizontal projection being greater than the inner circumference of the pipe, together with apparatus whereby the vertical disposition of the rim may be regulated so that it acts as the rim of a weir of variable height that is adapted to govern
i. the rate of flow of liquid out of and/or into the pipe, and/or
ii. respectively the surface level of a body of liquid which is
a. connected to liquid within the pipe, or
b. connected to liquid outside the pipe.

2. A weir valve arrangement as claimed in claim 1 herein the length of the rim or of its horizontal projection exceeds the inner circumference of the pipe by a factor of a least 2 to 1.

3. A weir valve arrangement as claimed in claim 1 wherein the rim is contained in a plane and is adapted to be disposed horizontally.

4. A weir valve arrangement as claimed in claim 1 wherein the rim comprises one or more upwardly extending projections.

5. A weir valve arrangement as claimed in claim 1 in which the expended upper end of the pipe member is in the form of a fish connected to the remainder of the pipe member so as to provide access into and out of the pipe member through a central base aperture.

6. A weir valve arrangement as claimed in claim 1 wherein the pipe member is telescopically mounted on or within a support.

7. A weir valve arrangement as claimed in claim 6 which comprises screw threaded mounting means whereby the vertical disposition of the rim may be regulated.

8. A weir valve arrangement as claimed in claim 6 which comprises rack and pinion means whereby the vertical disposition of the rim may be regulated.

9. A weir valve arrangement as claimed in claim 6 comprising liquid sealing means between the pipe member and its support in the form of one or more “O” rings.

10. A weir valve device in which an arrangement as claimed in claim 1 is housed within a chamber within which liquid may flow over the weir rim during operation either outwardly from the pipe member or, alternatively, inwardly into the pipe member.

11. Apparatus comprising a plurality of weir valve devices a claimed in claim 1 connected in parallel to receive an inflow of liquid with the weir rims of the several housed arrangements being set at different levels in sequence, the level of the lowest weir rim being below that of the next in line and, in the case of three or more devices, that of each subsequent weir rim above that of its predecessor in the sequence.

12. Deleted.

13. Deleted.

14. A corrugated plate for use in separating two masses of flowable matter having different specific gravities which comprises adjacent longitudinal grooves disposed between corresponding ridges, the depth of each groove being arranged to increase progressively simultaneously with a progressive decrease in the mean angle between the groove sides (as herein defined) along the one or other longitudinal direction.

15. Apparatus for separating two masses of flowable matter having different specific gravities which comprises at least one, and preferably a plurality of tilted corrugated plates as claimed in claim 14.

16. Apparatus as claimed in claim 15 adapted to separate a liquid and a flowable mass of particles of higher density in which the corrugated plates are tilted so as to allow downward flow of the liquid and particles to be separated over the upwardly facing surfaces of the plates along the direction of the grooves that increase progressively in the depth in the direction of flow.

17. Apparatus as claimed in claim 15 adapted to separate two liquids of different specific gravities (exemplified below by oil and water) which comprises a separation chamber together with means whereby a flow of the oil and water to be separated (referred to below as “the feed flow”) is caused to impinge against the lower end of one or more tilted plates located within the chamber and proceed upwardly in contact with the downwardly facing surface of the plate or plates along the direction in which the depth of the grooves increases progressively as the flow proceeds.

18. Apparatus as claimed in claim 17 which comprises downstream valve means for controlling the fluid surface level or levels within the separation chamber.

19. Apparatus as claimed in claim 18 in which the downstream valve means is constituted by a Tulip Valve as referred to herein.

20. Apparatus as claimed in claim 18 which comprises oil removal pipe inlets leading out of the separation chamber and in which the downstream valve means is adapted to be set to provide a fluid surface level within the separation chamber:
i. that is below but close to the level of any or each of the inlet rims when water alone passes through the chamber
ii. that will allow oil to flow over such inlet rim into its associated oil removal pipe when the oil surface level rises to the level of the rim upon the accumulation of floating oil around and/or proximate to such inlet rim.

21. Apparatus as claimed in claim 17 which comprises:
i. a plurality of corrugated plates as claimed in claim 1 arranged in sequence with each respective lower rim in sealed contact with the base of the separation chamber and each upper rim adapted to be submerged below water level during operation, and
ii. Barrier means located between successive plates in the sequence, the lower rim of each barrier being located above the base of the separation chamber so as to provide a gap adapted to allow the feed flow to pass below the barrier during operation and the upper rim of each barrier being adapted to extend above the fluid surface level during operation.

22. A modification of the apparatus as claimed in claim 21 in which Stacked Plate units as referred to herein are substituted for any or all of the corrugated plates and, in relation to each Stacked Plate unit, the reference to the lower rim in sealed contact with the base of the separation chamber is to be taken to be a reference to the lower rim that is lowest of the lower rims in any particular Stacked Plate unit.

23. Apparatus as claimed in either of claims 21 or 22 in which each or any of the fluid zones between successive barrier means is provided with an oil removal pipe inlet leading out of the separation chamber and in which the downstream valve means is adapted to set a fluid surface level within any such zone:
i. that is below but close to the level of the inlet rim of the oil removal pipe when water alone passes through the chamber, and
ii. that will allow oil to flow over such inlet rim into its associated oil removal pipe when the oil surface level rises to the level of the rim upon accumulation of floating oil around and/or proximate to the inlet rim.

24. Apparatus as claimed in claim 20 in which the level of the rim of the inlet of any of the oil removal pipes is adjustable vertically.

25. Apparatus as claimed in claim 17 which includes filter matrix means that is located downstream of the separation chamber and adapted to separate fine residual particles of oil from the feed flow.

26. Apparatus as claimed in any of claims 17 to 24 which includes fluid flow stabilising means located upstream of the separation chamber.

27. Apparatus as claimed in claim 26 in which the fluid flow stabilising means comprises a chamber that houses the device described herein and referred to as a “Clock Spring Guide”.

28. A method of separating oil from water in which an oil and water feed flow is passed through apparatus as claimed in claim 17.

29. Deleted.

30. Deleted.

31. A vortex chamber in the form of or comprising a device adapted to convert a flow of liquid entering the chamber into a vortex where the device includes a wall member having the configuration of a helix when seen in plan view that stands on a base member and defines a helical path of progressively diminishing radius adapted to receive the flow or a layer of the flow and guide the same along the said path to the zone around the centre of the helix, such zone comprising liquid outlet means passing through the base member.

32. A vortex chamber as claimed in claim 31 for the separation of oil and water adapted to receive a flow of oil and water entering the chamber and comprising means for the removal of oil from a discrete floating oil vortex formed within the chamber.

33. A vortex chamber as claimed in claim 32 in which the upper rim of the helical wall member is progressively lowered in the direction towards the centre.

34. A vortex chamber as claimed in claim 32 in which the oil removal means comprises an oil removal pipe having its inlet adapted to be located within the floating oil vortex when formed.

35. A vortex chamber as claimed in claim 32 in which the oil removal means comprises an oil removal pipe having its inlet rim adapted to be located at a level that is close to but above the surface level of water when a flow of water alone is passed through the chamber so that, upon the elevation of the fluid surface level within the vortex chamber accompanying the accumulation of oil within the floating oil vortex when formed, oil flows past the inlet rim and into the oil removal pipe.

36. A vortex chamber as claimed in claim 34 in which the oil removal pipe extends upwardly through middle part of the chamber and a horizontal baffle plate encircles the oil removal pipe at a level adapted to be below the floating vortex when formed.

37. A vortex chamber as claimed in claim 31 in which the rim of the outer circumferential coil of the helical wall member and that part of the rim of the first inner coil that lies at or adjacent to the mouth of the helix are adapted to stand proud of the fluid surface level of the flow of liquid entering the chamber through an inlet located at or adjacent to the mouth of the helix and above a barrier
i. that extends upwardly from the base to span the gap between the said outer and first inner coils, and
ii. that is adapted to terminate below the fluid surface level.

38. A vortex chamber as claimed in claim 31 that is adapted to be partially immersed in a body of oil containing water so as to admit a flow of oil and water.

39. A vortex chamber as claimed in claim 38 in which the liquid outlet means passing through the base member leads to a downwardly extending outlet pipe that is provided with means adapted to act on rotating water passing through the pipe to impel it downwardly.

40. An arrangement which comprises a vortex chamber as claimed in claim 3 8 and buoyant support means whereby the inlet to the vortex chamber may be adapted to face and admit into the chamber an oncoming relative flow of oil contaminated water.

41. A vortex chamber as claimed in claim 31 that is provided with a tangential entry port and that comprises a device which is adapted to impart rotational movement to the flow in the same direction as that imparted as a result of tangential entry.

42. A method of separating oil from water using a vortex chamber as claimed in claim 31 which includes the steps of
i. directing a flow or a component layer of a flow of oil and water along the helical path within the chamber so as to transform the flow into a whirling fluid mass within which oil floats as a discrete oil vortex buoyantly supported by whirling water;
ii. withdrawing oil from the oil vortex, and
iii. permitting water to escape through the liquid outlet means passing through the base member.

43. A method as claimed in claim 42 wherein use is made of a vortex chamber as claimed in claim 35 in which the oil removal pipe inlet is disposed so that oil from the oil vortex flows over the rim of the inlet into the pipe of its own accord under gravity when the fluid surface level of the oil rises as oil accumulates in the oil vortex.

44. A vortex chamber as claimed in claim 31 adapted to stabilise a liquid flow that is passed through it.

45. A method as claimed in claim 32 in which the flow of oil and water is firstly passed through a vortex chamber as claimed in claim 34.

46. Deleted.

47. Deleted.

48. Apparatus for separating oil from water, the apparatus comprising:
i. a vortex chamber adapted to admit through an inlet a flow of oil and water;
ii. means adapted to impart a rotational movement to the admitted oil and water so as to form within the chamber a rotating fluid mass within which a non-turbulent vortex of oil floats on the water;
iii. means for the removal of oil from the oil vortex;
iv. outlet means adapted to be located below the level of the floating oil for the escape of water from the vortex chamber, and
v. variable flow regulating means located at or downstream of the outlet means and adapted to regulate the rate of flow of water through the chamber.

49. Apparatus for separating floating oil from water which comprises:
i. a forward part adapted to receive a flow of water that bears a floating layer of oil;
ii. a vortex chamber located downstream of the forward part adapted to admit through an inlet an upper layer of the flow of water, together with the layer of oil floating thereon;
iii. means adapted to impart a rotational movement to the admitted oil and water so as to form within the chamber a rotating fluid mass within which a nonturbulent vortex of oil floats on the water;
iv. means for the removal of oil from the oil vortex;
v. outlet means adapted to be located below the level of the floating oil for the escape of water from the vortex chamber;
vi. bypass means having inlet means in the said forward part adapted to admit water from below the oil/water interface upstream of the vortex chamber inlet and to divert the admitted water past the vortex chamber; and
vii. variable flow regulating means adapted to regulate the rate of flow of water through the bypass means.

50. Apparatus as claimed in claim 48, further comprising a forward part adapted to receive a flow of water that bears a floating layer of oil, the vortex chamber being located downstream of the forward part and being adapted to admit through the inlet an upper layer of the flow of water together with the layer of oil floating thereon, the apparatus further comprising bypass means having inlet means in the forward part adapted to admit water from below the oil/water interface upstream of the vortex chamber inlet and to divert the admitted water passed the vortex chamber, and variable flow regulating means adapted to regulate the rate of flow of water through the bypass means.

51. Apparatus as claimed in claim 48 that comprises variable oil flow regulating means adapted to regulate the flow of oil on its removal from the oil vortex.

52. Apparatus as claimed in claim 49 or, insofar as it is dependent upon claim 49, claim 51 which comprises a vortex chamber inlet variable flow regulating means controlling the upper part of the vortex chamber inlet and adapted to regulate the flow of floating oil into the vortex chamber.

53. Apparatus as claimed in claim 52 in which the vortex chamber inlet variable flow regulating means comprises an hinged gate adapted to extend across the upper part of the vortex chamber inlet and opening to admit fluid flow into the vortex chamber.

54. Apparatus as claimed in claim 48, wherein the flow regulating means (whether eater, oil or oil/water) comprises in each or any case a sluice gate means.

55. Apparatus as claimed in claim 54 in which the sluice gate means comprises variable height weir means.

56. Apparatus as claimed in claim 8 in which the sluice gate means comprises a weir valve according to claim 1.

57. Apparatus as claimed in claim 48, wherein the means adapted to impart comprises a Clock Spring Guide as herein defined.

58. Apparatus as claimed in claim 48 which includes flow stabilising means adapted to act on the flow of oil and water upstream of the vortex chamber.

59. Apparatus as claimed in claim 58 in which the flow stabilising means comprises a Clock Spring Guide as herein defined.

60. Apparatus as claimed in claim 48 wherein the means for the removal of oil from the oil vortex comprises an oil removal pipe having its inlet adapted to be located within the floating oil vortex when formed.

61. A modification of the apparatus as claimed in claim 60, wherein the oil removal pipe has its inlet rim adapted to be located at a level that is close to but above the surface level of the water within the vortex chamber as controlled by the variable flow regulating means mentioned in claim 1 when water alone flows through the chamber so that, during operation, upon the elevation of the fluid surface level within the vortex chamber accompanying the accumulation of oil within the floating oil vortex, oil flows over the rim into the oil removal pipe.

62. Apparatus as claimed in claim 48 which includes means located along the path of flow between the vortex chamber outlet and the downstream variable flow regulating means for the removal of residual oil carried by the water emerging from the vortex chamber.

63. Apparatus as claimed in claim 62 in which the means for the removal of residual oil includes a tilted plate separator comprising one or a plurality of tilted corrugated plates located in a separation chamber.

64. Apparatus as claimed in claim 63 in which the fluid surface levels in both the vortex chamber and the separation chamber are regulated by the downstream variable flow regulating means.

65. Apparatus as claimed in claim 64 in which the corrugated plates are Lemer Plates as defined herein.

66. Apparatus as claimed in claim 65 in which the tilted plate separator comprises apparatus as claimed in claim 15.

67. Apparatus as claimed in claim 63 in which the tilted plate separator comprises oil removal pipes having their inlet rims adapted to be located at a level that is close to but above the level of the water within one or more surface oil accumulation zones in the separation chamber as controlled by the downstream variable flow regulating means when water alone flows through the chamber so that, during operation, upon the elevation of the fluid surface level in any zone accompanying the accumulation of separated oil within such zone, oil flows over the rim into its associated oil removal pipe.

68. Apparatus as claimed in claim 67 in which the level of the inlet rims is vertically adjustable.

69. Apparatus as claimed in claims 64 in which the downstream variable flow regulating means comprises a Tulip Valve as defined herein.

70. Apparatus as claimed in claim 48 which includes in the line of flow downstream of the vortex chamber filter matrix means adapted to separate fine particles of oil from the flow.

71. Apparatus as claimed in claim 70 insofar as it is dependent on claim 63 wherein the filter matrix means is located downstream of the separation chamber.

72. Apparatus for the separation of oil and water as claimed in claim 48 adapted to be partially immersed in a body of water so as to admit fluid flow into the vortex chamber.

73. An arrangement that comprises apparatus as claimed in claim 72 together with water impelling means located downstream of the vortex chamber outlet that is adapted to draw water out of the outlet.

74. An arrangement as claimed in claim 73 that is adapted to be buoyantly supported on a body of water with the water impelling means adapted to propel the arrangement through the water with the vortex chamber inlet facing the direction of movement.

75. An arrangement as claimed in claim 73 wherein the water impelling means is a marine outboard engine.

76. Deleted.

77. Deleted.
